(19) United States
(12) Patent Application Publication
(10) Pub. No.: US 2014/0258788 A1
(43) Pub. Date: Sep. 11, 2014

(54) RECORDING MEDIUM STORING PERFORMANCE EVALUATION SUPPORT PROGRAM, PERFORMANCE EVALUATION SUPPORT APPARATUS, AND PERFORMANCE EVALUATION SUPPORT METHOD

(71) Applicant: FUJITSU LIMITED, Kawasaki-shi (JP)

(72) Inventor: Tetsutaro MARUYAMA, Kawasaki (JP)

(73) Assignee: FUJITSU LIMITED, Kawasaki-shi (JP)

(21) Appl. No.: 14/178,322

(22) Filed: Feb. 12, 2014

(30) Foreign Application Priority Data
Mar. 11, 2013 (JP) 2013-048486

(51) Int. Cl. G06F 11/34

(52) U.S. Cl. CPC G06F 11/3452
USPC 714/47.3

(57) ABSTRACT

A program directs a computer to perform processes of acquiring information about a configuration of each storage device group which have a different response efficiency to a request, and information about a maximum response time to the request of each storage device group, calculating a maximum request issuance frequency as a request issuance frequency per unit time as the maximum response time when a response time is checked for each storage device group, calculating an cumulative value of a number of issuance of requests to each storage device group from a Zipf distribution when the request issuance frequency to a unit capacity in storage device groups and a probability of the request issuance frequency are in accordance with the Zipf distribution, and generating an evaluation reference value about the storage device group using the maximum request issuance frequency and the cumulative value of the number of issuances of the request.

### CROSS-REFERENCE TO RELATED APPLICATIONS

This application is based upon and claims the benefit of priority of the prior Japanese Patent Application No. 2013-048486, filed on Mar. 11, 2013, the entire contents of which are incorporated herein by reference.

### FIELD

An aspect of an embodiment of the present invention is related to performance evaluation support of a storage system.

### BACKGROUND

Hierarchical storage refers to a system of combining storage media having different prices per performance and capacity unit, and compatibly realizing two features of high performance and low price.

There is the first technology relating to the hierarchical storage. In the first technology, different hierarchical pages in a storage system are mapped on storage devices of different speeds including at least one high-speed storage device corresponding to a high hierarchical page, and one low-speed storage device corresponding to a low hierarchical page. The sub-file hierarchical management is performed for each large file which is larger than a page size to adapt the access feature of each part of the large file to a hierarchical component of a page assigned a mixed volume. Thus, the large file is assigned among the pages of different hierarchical components according to the access features of different parts of the large file. Thus, the data positions of a plurality of files are managed for a storage system having a fixed page size and a mixed volume including a plurality of pages which belong to different hierarchical components.

There is the second technology as another technique relating to the hierarchical storage. In the second technology, a disk array control unit includes a CPU (central processing unit) and a statistical information storage device. The CPU includes a performance execution device which judges the applicability of the configuration of a logical disk. The statistical information includes a reference response time determination device. The reference response time determination device applies a load of an input/output command, and adds the initial reference value obtained by practically measuring a processing performance information and the processing performance information obtained when input/output command processing is executed in a normal operation to the statistical data. This, a reference value of appropriate performance is determined.
Patent Document 1: Japanese Laid-open Patent Publication No. 2011-192259
Patent Document 2: Japanese Laid-open Patent Publication No. 2011-503754
Patent Document 3: Japanese Laid-open Patent Publication No. 2010-113383

### SUMMARY

According to an aspect of an embodiment of the present invention, the performance evaluation support program allows a computer to perform the following processes. The computer acquires the information about the configuration of each of a plurality of storage device groups and the information about the maximum response time for a request of each of the plurality of storage device groups. The plurality of storage device groups have different response efficiencies for a request including at least a read request and a write request. Using the acquired information, the computer calculates the maximum request issuance frequency as the request issuance frequency per unit time with which the response time is the maximum response time for each of the plurality of storage device groups. When the request issuance frequencies to a unit capacity of the plurality of storage device groups which are arranged in the order from the highest frequency, and the probability of the request issuance frequency are in accordance with the Zipf distribution, the computer calculates the cumulative value of the number of issues of requests for the storage device groups for each storage device group from the Zipf distribution. The computer generates an evaluation reference value about the performance of a storage device group using the maximum request issuance frequency and the cumulative value of the number of issues of requests.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram of a performance evaluation support device according to an embodiment of the present invention;

FIG. 2 is an example of a hierarchical storage device;

FIG. 3 is an example of a configuration of hierarchical storage;

FIGS. 4A and 4B are explanatory views of allocating the capacity of a hierarchical volume;

FIG. 5 is an explanatory view of a capacity optimization threshold, a performance optimization threshold, a set load threshold, a capacity rate threshold relative to a maximum load threshold, and an I/O frequency threshold;

FIG. 6 illustrates a Zipf distribution for the frequency of a sub-LUN having the k-th highest frequency of the number of issues of I/O per unit time;

FIG. 7 is an explanatory view of calculating a load on each hierarchical component;

FIGS. 8A and 8B are explanatory views of the method of calculating the maximum load;

FIGS. 9A and 9B are explanatory views of an expectation value of the number of stripe blocks in a span of a read in the first embodiment of the present invention;

FIG. 10 is a block diagram of the hardware of a computer which performs an optimum capacity threshold and optimum performance threshold calculating process according to the first embodiment;

FIGS. 11A through 11C are flowcharts of the optimum capacity threshold and optimum performance threshold calculating process according to the first embodiment;

FIG. 12 illustrates a result of measuring a virtual write cost (V) of each RAID level and block size of three disks;

FIGS. 13A through 13C are examples of an input screen according to the first embodiment;

FIGS. 14A through 14D are examples of an output screen according to the first embodiment;

FIG. 15 illustrates the relationship between the I/O frequency for each read rate for the RAID configured by the SSD and its response time;

FIGS. 16A and 16B are explanatory views of reducing the usage capacity of the hierarchical component which is the bottleneck of the performance;

FIGS. 17A and 17B illustrate the relationship between the number of sub-LUNs reduced from the hierarchical component which is the bottleneck of the performance and the entire performance calculated from each hierarchical component;

FIGS. 18A and 18B are flowcharts of the optimum performance and optimum usage capacity calculating process in the second embodiment of the present invention;

FIGS. 19A and 19B are examples of an input screen according to the second embodiment; and

FIG. 20 is an example of an output screen according to the second embodiment.

### DESCRIPTION OF EMBODIMENTS

Since the hierarchical storage is constructed by combining storage devices depending on the performance, it is difficult to manage the input/output load on each storage device, and to adjust the distribution of resources such as the arrangement of storage devices, the distribution of load, etc. Thus, it is not easy to evaluate the performance as a guide to an operation in operating a storage system.

An aspect of the present embodiment provides the technology of performing evaluation support of the performance of a storage system.

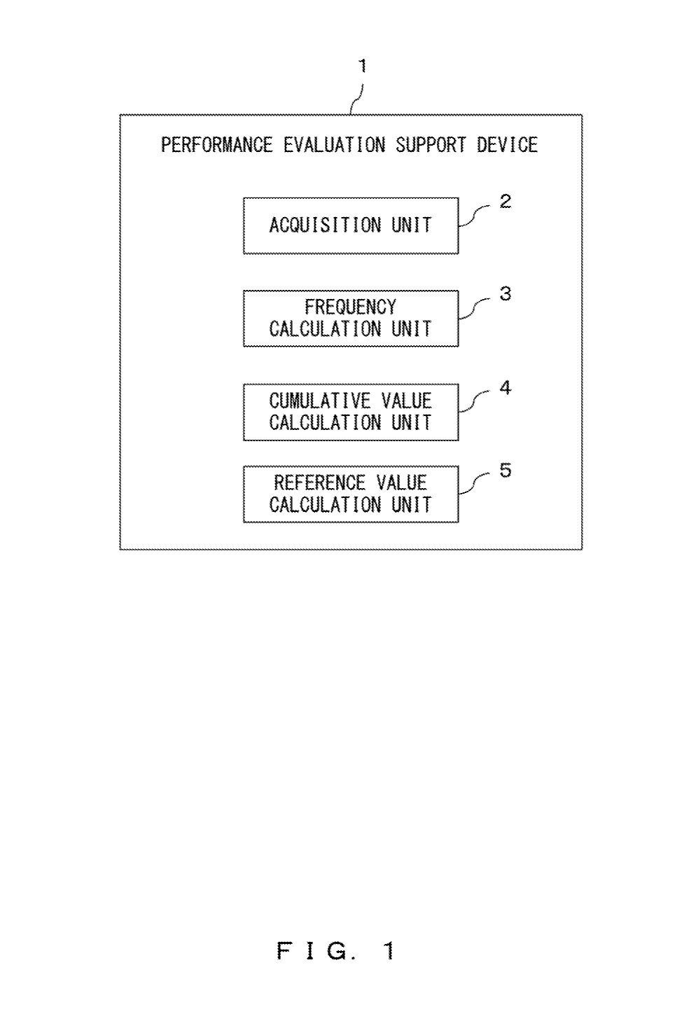

FIG. 1 is a block diagram of a performance evaluation support device according to the present embodiment. A performance evaluation support device 1 includes an acquisition unit 2, a frequency calculation unit 3, a cumulative value calculation unit 4, and a reference value calculation unit 5.

The acquisition unit 2 acquires the information about the configuration of each of a plurality of storage device groups included in a storage system and the information about the maximum response time for a request of each of the plurality of storage device groups. The plurality of storage device groups have different response efficiencies for the request including at least a read request and a write request. A processor such as a CPU 22 etc. is used as an example of the acquisition unit 2, Concretely, the acquisition unit 2 acquires redundancy system information, the number of storage devices expressed depending on the redundancy system, a usage capacity, the rate of a read request, an average I/O data size, an average response time, a constant of internal processing time, and a storage device constant. The redundancy system information (RAID (redundant arrays of independent disks) level) is related to the data redundancy system in the storage system. The number of storage devices (RAID members) is expressed depending on the redundancy system by discriminating the number of storage devices (RAID rank) which configure a RAID stripe from the number of storage devices which store parity data depending on the redundancy system. The rate of a read request (read rate) is the rate of a read request for the request including a read request and a write request. The average I/O data size refers to the average data size of the data read or written upon receipt of the read request and the write request. The constant of the internal processing time (vitual write cost) indicates the internal processing time for the write request in a storage system. The storage device constant (disk constant) is determined by the type of storage device.

Using the acquired information, the frequency calculation unit 3 calculates the maximum request issuance frequency as a request issuance frequency per unit time with the maximum response time as a response time for each of the plurality of storage device groups. A processor such as the CPU 22 etc. is used as an example of the frequency calculation unit 3. The frequency calculation unit 3 converts the average I/O data size read from each storage device group into an expectation value (expectation value of the number of stripe blocks in the span of I/O) of the number of storage devices read or written depending on the read request or the write request. The frequency calculation unit 3 calculates the redundancy coefficient (RAID coefficient) indicating the amount of feature for the data redundancy system for each storage device group using the RAID level, the RAID rank, and the expectation value of the number of stripe blocks in the span of I/O. The frequency calculation unit 3 calculates the storage device coefficient (disk coefficient) indicating the amount of feature for the performance of each storage device using the RAID level, the RAID rank, the expectation value of the number of stripe blocks in the span of I/O, a use rate (v=1), and the disk constant. The frequency calculation unit 3 calculates the reciprocal change multiplicity using the disk coefficient, the RAID coefficient, the read rate, and the virtual rite cost. The reciprocal change multiplicity refers to the multiplicity as the boundary between the low load phase in which the response time is constant for the number of requests and the high load phase in which the multiplicity indicating the number of read requests from or write requests to the storage device which overlap per unit time for the number of requests exponentially increases. The frequency calculation unit 3 calculates the maximum value of the IOPS (input output per second) as the number of input/output (I/O frequency) per unit time of each storage device group as a maximum request issuance frequency by calculating the approximate value of the inverse function of a performance model in the equation (1) described later using the average response time, the RAID coefficient, the disk coefficient, and the reciprocal change multiplicity.

When the request issuance frequencies to a unit capacity of the plurality of storage device groups which are arranged in the order from the highest frequency, and the probability of the request issuance frequency are in accordance with the Zipf distribution, the cumulative value calculation unit 4 calculates the cumulative value of the number of issues of requests for the storage device groups for each storage device group from the Zipf distribution. The Zipf distribution refers to the distribution based on the rule of thumb that the rate of an element having the k-th highest frequency of occurrence is proportional to 1/k (k is an integer). An example of the cumulative value calculation unit 4 is a processor such as the CPU 22 etc.

The reference value calculation unit 5 generates an evaluation reference value relating to the performance of a storage device group using the maximum request issuance frequency and the cumulative value of the number of issues of requests. An example of the reference value calculation unit 5 is a processor such as the CPU 22 etc.

With the above-mentioned configuration, evaluation support relating to the performance of a storage system may be realized.

The reference value calculation unit 5 assigns the capacity equal to the logical capacity of the first storage device group to the first storage device group having the highest response efficiency in a plurality of storage device groups. The reference value calculation unit 5 calculates the capacity having the maximum value of the request issuance frequency at which a reply may be issued in the maximum response time to the storage device group other than the first storage device group using the cumulative value of the number of issues of requests of a storage device group.

With the above-mentioned configuration, the capacity rate threshold of each hierarchical component in the case of the performance optimization may be calculated.

The reference value calculation unit 5 calculates the ratio of the logical capacity of each of a plurality of storage device groups. With the configuration, the capacity rate threshold of each hierarchical component in the case of the capacity optimization may be calculated

The reference value calculation unit 5 calculates the request issuance frequency per unit time in a storage device group using the request issuance frequency per unit time for the entire storage device groups specified in advance and the Zipf distribution. With the above-mentioned configuration, the I/O issue threshold in the hierarchical components under the set load condition in the capacity optimization and performance optimization.

The reference value calculation unit 5 calculates the request issuance frequency per unit time in the storage device groups using the smallest value obtained by dividing the maximum request issuance frequency of each storage device group by the cumulative value of the number of issues of requests and the Zipf distribution. With the above-mentioned configuration, the I/O frequency threshold in the hierarchical components under the maximum load condition in the capacity optimization and performance optimization.

The reference value calculation unit outputs the smallest value in the values obtained by dividing the maximum request issuance frequency of each storage device group by the cumulative value of the number of issues of requests to the storage device group. With the above-mentioned configuration, the maximum load (optimum performance) which may satisfy the condition of the average response in all hierarchical components may be calculated.

In the values obtained by performing the division above, the reference value calculation unit 5 compares the values corresponding to the second and third storage device groups as the storage devices in the groups other than the first storage device group which has the highest response efficiency in a plurality of storage device groups. As a result of the comparison, the storage device group corresponding to the smaller value is determined. The reference value calculation unit calculates the storage capacity with which the largest number of requests may be processed by the storage device group by reducing the storage capacity of the determined storage device group from the maximum capacity. With the above-mentioned configuration, the capacity of the maximum performance (optimum usage capacity) may be calculated when the usage capacity is decreased while satisfying the condition of the average response of each hierarchical component.

The present embodiment is described below in detail.

### First Embodiment

Described in the first embodiment is the technology of providing the capacity rate threshold and the I/O frequency threshold as the guide to the operation when the operation is performed under the conditions of the capacity optimization, the performance optimization, the set load, and the maximum load.

The storage is a medium (hard disk etc.) for storing data, or a device configured by the media. In the first embodiment, since RAID (redundant arrays of independent disks) is described as an example of a device whose performance is to be predicted, the storage is equivalent to the RAID.

The RAID is the technology of distributing data and storing the data with redundancy using a plurality of media, and refers to the technology of realizing the improvement of performance and the reliability (data is not lost although the storage medium becomes faulty), or a device (RAID device) for storing data using the technology described above. The RAID device includes necessary components (a disk device (storage medium), a controller (CPU), cache (memory)) for realizing the RAID, and they are referred to as a RAID disk, a RAID controller, RAID cache respectively.

There are various types of RAID depending on the implementing method, and each type is assigned a number (RAID 1, RAID 5, RAID 6, etc.). The number is referred to as a RAID level. For example, the RAID level of the RAID 5 is “5”.

A RAID member has a different data distribution system and redundancy creating system depending on the RAID level, and expresses the systems by equations. In the case of the RAID 5, a piece of parity data is generated for realizing data redundancy for a RAID stripe as a data division unit. Therefore, it is expressed as “4+1” with the number of divisions which configured stripes. In the case of the RAID 6, two pieces of parity data are generated for the RAID stripe. Therefore, it is expressed as “6+2”. The number of necessary RAID disks when the RAID is created is the value obtained by calculating an expressed equation. For example, RAID 5 4+1 requires five disks.

The RAID rank is obtained by extracting the number of divisions which configure a RAID stripe for the RAID member. For example, the RAID rank of RAID 5 4+1 is 4.

The I/O (input/output) has the same meaning as read/write, and refers to a read command or a write command, that is, the input/output to the storage. From the viewpoint of the storage, a read is defined as output, a write is defined as input.

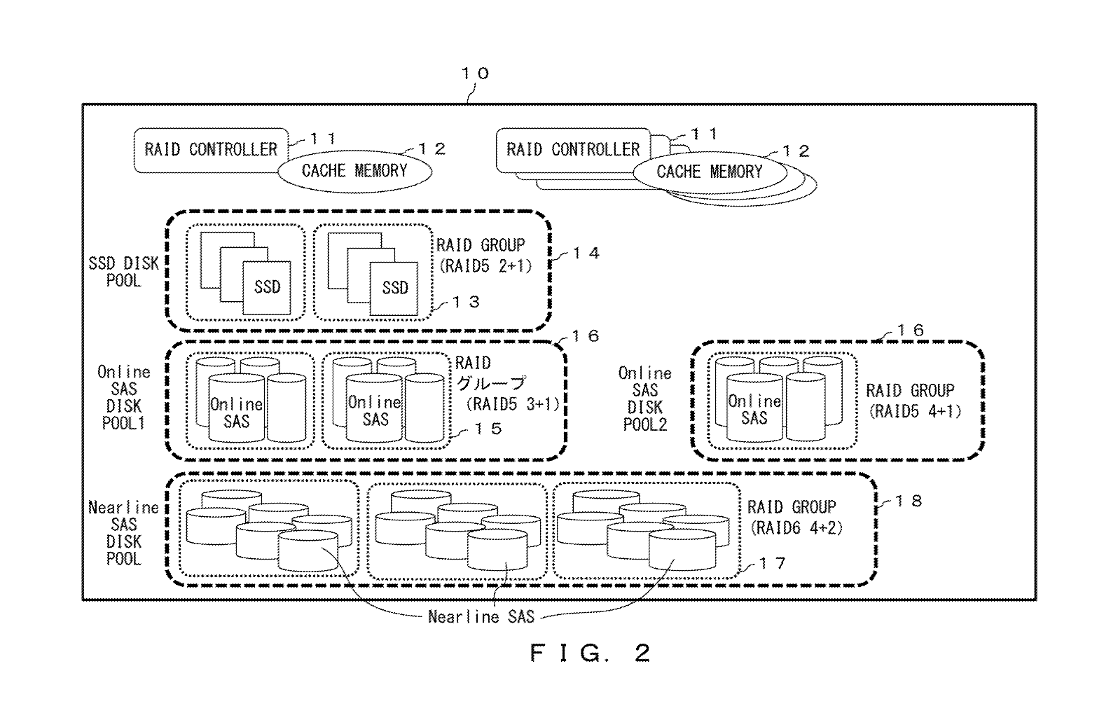

FIG. 2 is an example of a hierarchical storage device. According to the following definition, a disk pool is hierarchically structured, and a hierarchical storage device 10 is generated. The hierarchical storage device 10 includes a RAID controller 11, cache memory 12, an SSD disk pool 14, an Online SAS disk pool 16, and a Nearline SAS disk pool 18.

The hierarchical storage refers to a system of compatibly realizing two features, that is, high performance and low price, by combining storage media having different prices per performance-capacity unit such as an SSD, an Online SAS, aNearline SAS, etc. The SSD indicates a solid state drive. The SAS indicates a serial attached SCSI (small computer system interface). The hierarchical storage is realized by adding a hierarchical storage function to the RAID device which generates redundant data.

In the hierarchical storage device 10, each storage device of the SSD, the Online SAS, and the Nearline SAS creates a RAID. A plurality of storage devices which create the RAID is referred to as a RAID group (13, 15, 17). The RAID groups configured by the same storage device, RAID type, and RAID member is referred to as a disk pool (14, 16, 18).

A normal RAID assigns a capacity from one disk pool and creates a logical volume. The logical volume which uses a hierarchical storage function assigns a capacity from a plurality of disk pools. The logical volume which uses the hierarchical storage function is referred to simply as a hierarchical volume. In the logical volume, high performance is realized by arranging data indicating a high access frequency in a disk pool configured by a high-speed disk-RAID.

In the logical volume, a large capacity and a low price are realized by arranging data indicating a very low access frequency in a disk pool configured by a low-speed (low price) disk-RAID. The I/O frequency is access frequency expressed by an average number of issuing a read or write request per second, and is evaluated by a unit of IOPS (input output per second).

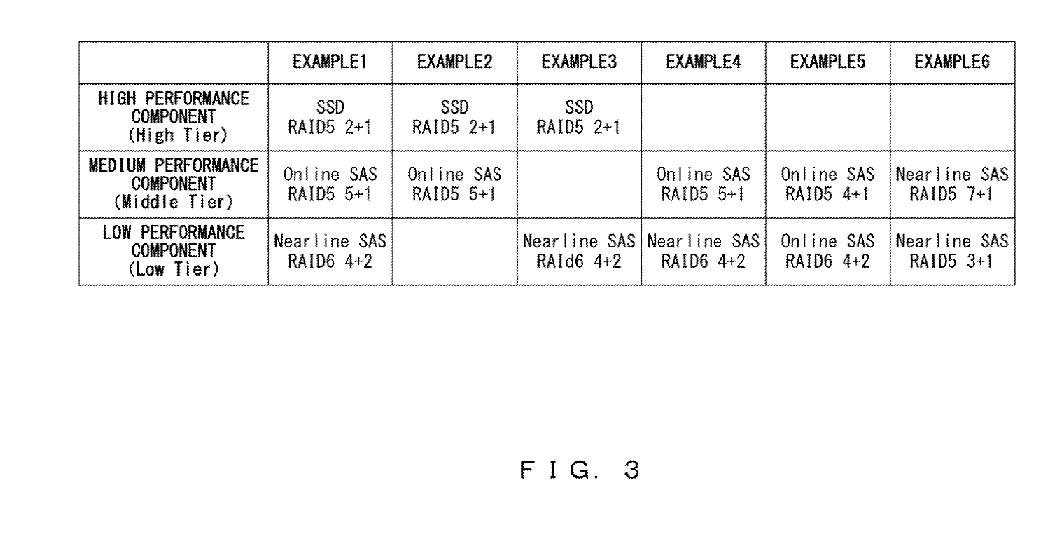

The SSD, the Online SAS, and the Nearline SAS are used as disks which configure the RAID. It is defined that higher performance is assigned to the SSD, the Online SAS, and the Nearline SAS in this order. When the same disk is used to configure the RAID, it is defined that higher performance is assigned to the RAID 5 and the RAID 6 in this order. When the same disk is used to configure the RAID, and the same RAID level is used, it is defined that the one assigned a higher RAID rank has higher performance. For example, the hierarchical storage is configured by three or two hierarchical components. Assume that a high performance component corresponds to the RAID which is configured by the SSD. FIG. 3 is an example of a configuration of the hierarchical storage (hereafter referred to as a hierarchical configuration).

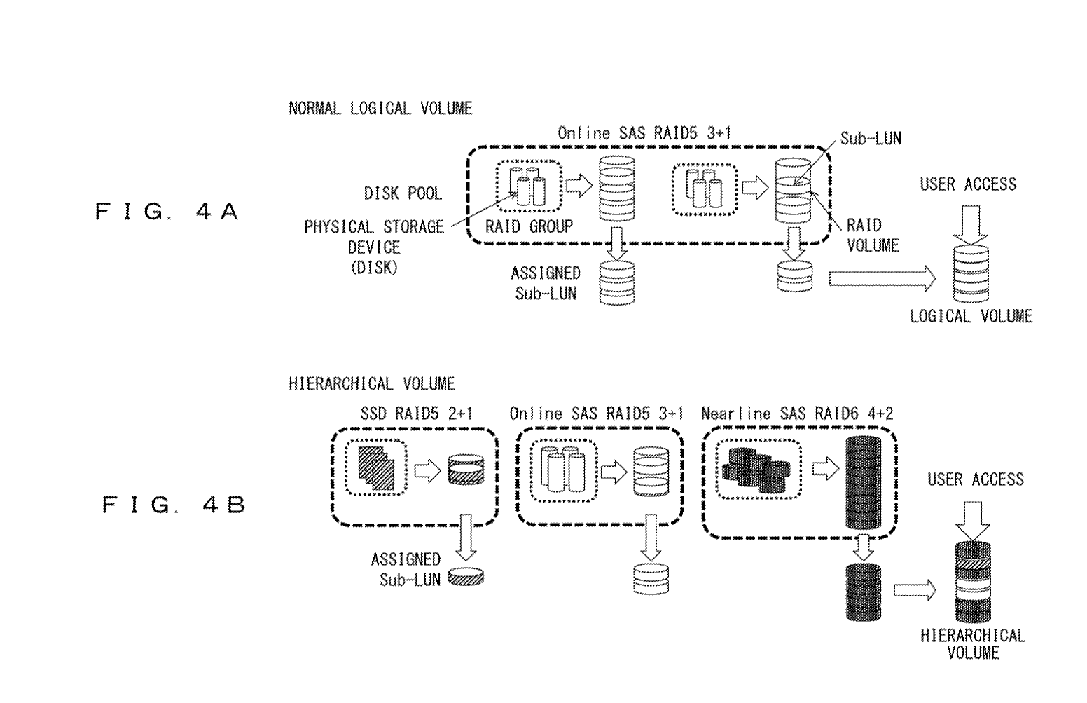

The assignment of a capacity of a hierarchical volume is described below with reference to FIGS. 4A and 4B. As illustrated in FIG. 4A, in the case of a normal logical volume, a logical volume referred to as a RAID volume is generated for each RAID group. The RAID volume is divisionally managed by the unit of sub-LUN (logical unit number) which is a management unit more detailed than the LUN (logical unit number).

When a logical volume is newly generated, the necessary number of sub-LUNs in any RAID volume (not used in another logical volume) are assigned. The assigned and combined sub-LUNs (in an optional order) are defined as a logical volume to be accessed by a user.

On the other hand, as illustrated in FIG. 4B, when a hierarchical volume is newly generated, an appropriate number of sub-LUNs are assigned from an optional RAID volume of the storage pool specified in the hierarchical configuration. The assigned sub-LUNs are combined (in an optional order) as a hierarchical volume to be accessed by a user. The hierarchical storage function is realized by transferring the sub-LUN of a higher access frequency to a higher hierarchical level and transferring the sub-LUN of a lower hierarchical level. When the sub-LUN is practically transferred, an optional sub-LUN (destination sub-LUN) at the destination hierarchical level is newly assigned, the contents of the sub-LUN (source) to be transferred to the destination sub-LUN are copied, and the assignment of the source sub-LUN is released. Thus, the transfer of the sub-LUN is realized.

Described next is the name relating to the capacity to be used in the first embodiment. The total capacity of a RAID group or each hierarchical component (disk pool) which is calculated from the total capacity of a physical storage device (disk) is referred to as a logical capacity. For example, when the RAID 5 (3+1) is composed using a disk whose physical capacity is 600 [GIB), the logical capacity of the RAID group is 1800 [GB]. The logical capacity of the hierarchical component configured by five RAID groups above is 9000 (GB].

To configure (a plurality of) volumes, the capacity assigned from a RAID group or each hierarchical component (disk pool) (in a sub-LUN unit) is referred to as a usage capacity. For example, when an area of 900 [GB] is assigned from a RAID group having the logical capacity of 1800 [GB] is assigned to (a plurality of) volumes, the usage capacity of the RAID group is 900 [GB].

In a RAID group or each hierarchical component, the rate of the usage capacity to the logical capacity is referred to as a use rate. For example, the usage capacity of the RAID group having the logical capacity of 800 [GB] is 900 [GB], the use rate of the RAID group is 50%.

In a hierarchical volume, the rate of the capacity assigned from each hierarchical component is referred to as a capacity ratio. For example, when a hierarchical volume of 10 [TB](terabyte) is configured by 1 [TB] from the high performance component, 4 [TB] from the medium performance component, and 5 [TB] from the low performance component, the capacity ratios of the high performance component, the medium performance component, and the low performance component are 10%, 40%, and 50% respectively.

Described next are the capacity rate threshold system and the I/O frequency threshold system. The hierarchical storage measures the access frequency to a sub-LUN in a specified period, and determines the sub-LUN which is transferred based on the obtained value. The system of determining the sub-LUN to be transferred includes the capacity rate threshold system and the I/O frequency threshold system.

The capacity rate threshold system refers to a system of specifying the capacity ratio for a hierarchical configuration or a hierarchical volume by specifying a certain percent of the number of sub-LUNs is to be assigned from the high performance component, and a certain percent from the medium performance component. For example, when it is specified that, for the hierarchical volume which requires 100 sub-LUNs, 5% is assigned from the high performance component, and 20% is assigned from the medium performance component, 5 higher access frequency sub-LUNs are assigned from the high performance component. The 20 next higher access frequency sub-LUNs are assigned from the medium performance component. The 75 remaining sub-LUNs are assigned from the low performance component.

The I/O frequency threshold system refers to a system of directly specifying I/O frequency (access frequency) for a hierarchical configuration or a hierarchical volume by specifying the assignment is performed from the high performance component for a certain I/O frequency or more, and from the low performance component for a certain I/O frequency or less.

In both the capacity rate threshold system and the I/O frequency threshold system, the hierarchical component to which each sub-LUN is assigned by sorting the sub-LUNs by the access frequency based on the measured value in the evaluation period (in which the access frequency is measured). Then, the sub-LUN different from the hierarchical component to which the sub-LUN is practically assigned is transferred. In the first embodiment, the capacity rate threshold, and the I/O frequency threshold are collectively referred to as a threshold.

In the case of the capacity rate threshold system, the capacity rate threshold is often set to the same value as the rate of the logical capacity of each hierarchical component in the hierarchical configuration. When the logical capacity of the high performance component is 1 [TB], the logical capacity of the medium performance component is 5 [TB], and the logical capacity of the low performance component is 89 [TB], a setting is often made so that 4% (1/25=0.04) is assigned from the high performance component, 20% (5/25=0.2) is assigned from the medium performance component. With the settings, the operation may be performed safely although the usage capacity increases.

However, in any of the capacity rate threshold system and the I/O frequency threshold system, only one threshold is calculated for a hierarchical configuration. It is preferable that some thresholds are calculated for a hierarchical configuration, and an appropriate threshold is set and operated depending on the use of a hierarchical storage. The hierarchical storage has higher performance when there is a free capacity for a logical capacity. A user who requires higher storage requests a usage for performing an operation with a threshold which allows the most efficient performance of the entire hierarchical storage.

When the storage device or the RAID device is operated, the performance restriction condition (maximum response) is set, and used as an index of the operation. For example, in the case of the RAID configured by Online SAS disks, it is judged that an excess load is applied on the storage when the average response exceeds 0.020 [sec)], and it is preferable that the load is distributed. The value of the average response is referred to as the maximum response.

Then, relating to the hierarchical storage it is considered that the maximum response is set for each hierarchical component, and the restrictive condition is observed. For example, 0.050 [sec] is set as an average response for the SSD component, 0.020 [sec] is set as an average response for the Online SAS component, and 0.030 [sec] is set as an average response for the Nearline SAS component. When the hierarchical storage is operated, the operation is performed so that the average response does not exceed these values in the respective components.

Since the hierarchical storage acquires a performance statistical value (average I/O frequency or average response) for each hierarchical component in many cases, the performance statistical value may be confirmed. Since the hierarchical storage is a device for transferring the sub-LUN based on the performance statistical value for each sub-LUN, the performance statistical value is measured for each sub-LUN. If the performance statistical value for each sub-LUN is averaged, the performance statistical value for each hierarchical component may be calculated. In the first embodiment, the above-mentioned restrictive condition on the response is referred to as a response condition.

In the first embodiment, the four types of thresholds, that is, the capacity optimization threshold, the performance optimization threshold, the maximum load threshold, and the set load threshold, are calculated as described below for a specified hierarchical configuration.

Described first is the capacity optimization threshold. The usage capacity is assigned using the ratio of the logical capacity of each hierarchical component as a capacity ratio, and, under the condition, the calculation is performed using the capacity rate threshold and the I/O frequency threshold as the capacity optimization threshold. With the application, the entire hierarchical configuration may be efficiently used.

Described next is the performance optimization threshold. A value different from the ratio of the logical capacity is set as a capacity ratio of each hierarchical component. Thus, the use rate in each hierarchical component is intentionally biased. Generally, when the hierarchical storage has a free capacity, it functions with high performance. The capacity ratio is calculated so that the highest performance may be obtained, and, under the condition, the calculation is performed using the capacity rate threshold and the I/O frequency threshold as the performance optimization threshold. With the application, the performance of the hierarchical configuration may be used with the highest performance.

The capacity optimization threshold and the performance optimization threshold are further classified into the following two types of thresholds. The threshold (capacity rate threshold and I/O frequency threshold) which may satisfy the response condition in each hierarchical component, and is obtained when the heaviest load is applied is referred to as a maximum load threshold. The threshold (capacity rate threshold and I/O frequency threshold) obtained when a load of a specified value is applied is referred to as a set load threshold. With respect to the further classification of the type of the threshold the capacity rate threshold is the same because it is independent of the load. However, since the I/O frequency threshold depends on the load, it is a different value.

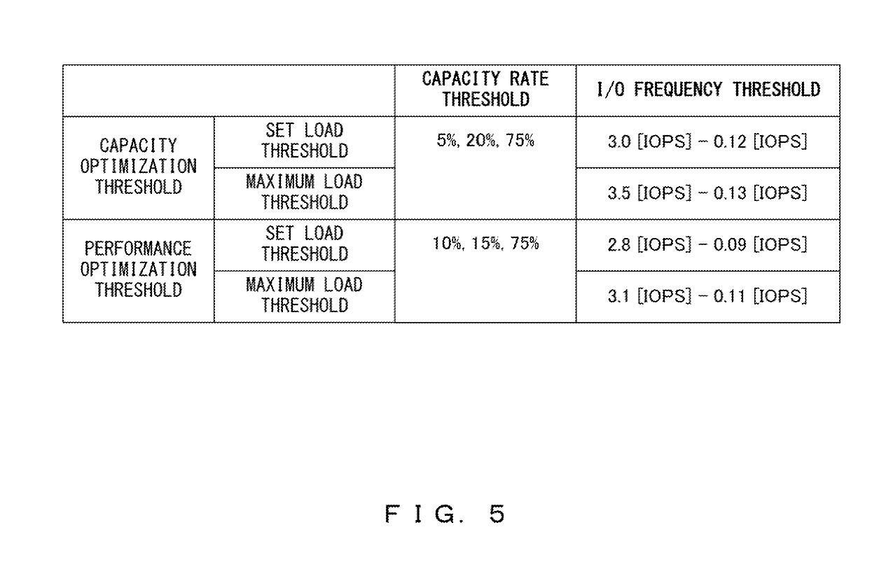

Described below is the summary of the types of the thresholds. As illustrated in FIG. 5, the capacity optimization threshold and the performance optimization threshold are further classified into a set load threshold and a maximum load threshold. The capacity rate threshold keeps the same value regardless of the set load or the maximum load. The capacity rate threshold is expressed as a capacity ratio to each hierarchical component. In FIG. 5, the capacity ratio of the high performance component, the medium performance component, and the low performance component is 5%:20%:75% for the capacity optimization threshold, and 10%:15%:75% for the performance optimization threshold.

The I/O frequency threshold has four types of thresholds, that is, the capacity optimization threshold, the performance optimization threshold, and their respective set load threshold and maximum load threshold. When the I/O frequency threshold is expressed by 3.0 [IOPS]-0.12 [IOPS] as the form of the value of the I/O frequency in the sub-LUN unit among the hierarchical components, it is assumed that the sub-LUN of the I/O frequency of 3.0 or more is assigned to the high performance component, and the sub-LUN of the I/O frequency lower than 0.12 is assigned to the low performance component.

The hierarchical storage is based on the bias of the access frequency of the user to the sub-LUN. The stored data may be frequently accessed or rarely accessed. That is, when there is no bias in the access frequency of the user to the sub-LUN, the effect of the hierarchical storage function does not work at all. A general probability distribution which expresses the bias may be the Zipf distribution.

Described below is the Zipf distribution. The rule of thumb that the ratio of the element having the k-th highest frequency of occurrence is proportional to 1/k (k is an integer) is referred to as a Zipf's law. The rule of thumb is well known as applicable to the access frequency of a Web page, the population of a city, the frequency of a word appearing in a work, the use frequency, the magnitude of an earthquake, etc. The probability distribution (discrete distribution) according to the law is referred to as the Zipf distribution.

Therefore, it is assumed in the first embodiment that when the sub-LUN is sorted for each access frequency, the distribution is in accordance with the Zipf distribution.

The Zipf distribution is expressed by the following equation.

$$f ( k ; N ) = \frac{1 / k}{{\sum }_{n = 1}^{N} 1 / n}$$

f (k; N): the frequency of the sub-LUN having the k-th highest frequency (=I/O frequency) in the N sub-LUNs

N: the number of sub-LUNs to be used

Σₖ₋₁^{N}f(k;N)=1

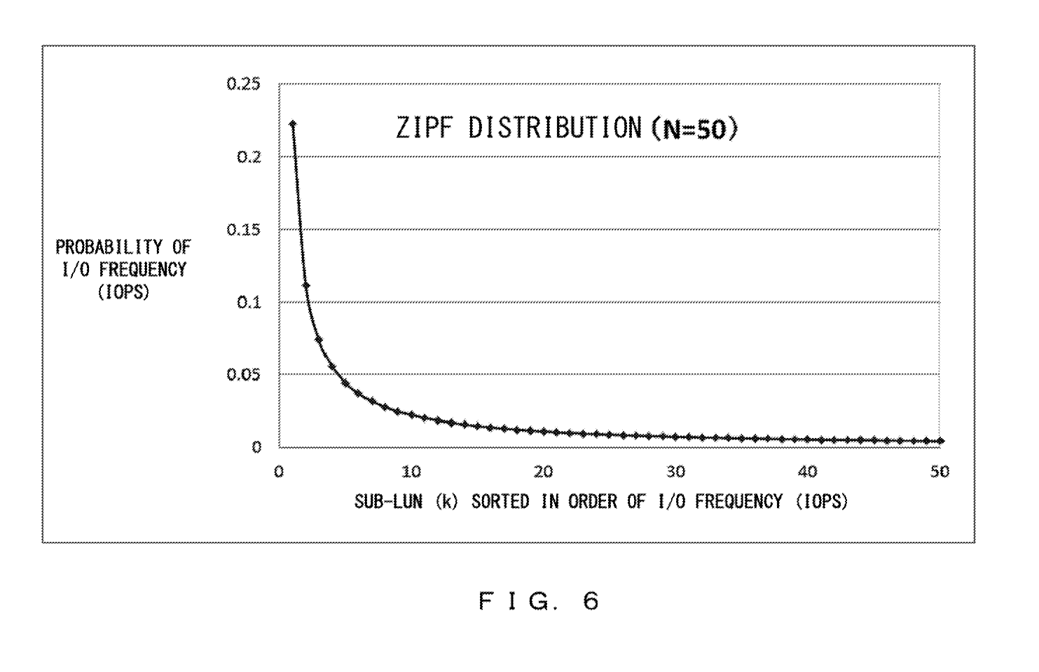

When X indicates the load (I/O frequency) relating to the entire hierarchical structure, the I/O frequency of the sub-LUN having the k-th highest frequency in Xf (k; N) is obtained as illustrated in FIG. 6.

In the first embodiment, the heaviest load with which the average response time is an optional value is calculated using the performance model expressed by the following equation (1).

$${W}_{R} = \frac{ɛ A ( {e}^{\frac{α}{ɛ} ( {X}_{R} - \frac{ɛ}{α A} )} - 1 ) + ɛ}{{X}_{R}} ( {X}_{R} \geq \frac{ɛ}{α A} ) , \\ {W}_{R} = α A ( {X}_{R} \leq \frac{ɛ}{α A} ) \qquad ( 1 )$$

IN CASE OF RAID5:

$$A = \frac{1}{2} \frac{R}{{E}_{R} - 0.25} , α = \frac{{E}_{R} - 0.5}{R} D \sqrt{\frac{v + 0.5}{1.5}}$$

IN CASE OF RAID6:

$$A = \frac{2}{3} \frac{R}{{E}_{R} - 0.25} , α = \frac{3}{4} \frac{{E}_{R} - 0.5}{R} D \sqrt{\frac{v + 0.5}{1.5}}$$

$$ɛ = \frac{c α A}{c α A + ( 1 - c ) V}$$

“R” indicates the RAID rank. “E_{R}” indicates an expectation value of the number of stripe blocks in the range of the read command. “D” indicates a disk constant. “v” indicates a volume usage ratio. “V” indicates a virtual write cost. “c” indicates a read ratio.

Since the write command is based on the 100% cache hit, the average response time (W) may be set to calculate the read response (W_{R}) from the constant write response (W_{W}) by the following equation.

W_{R}(1/c)(W−(1−c)W_{W})

The read I/O frequency (X_{R}) may be calculated by solving the equation of the performance model of the equation (1). Furthermore, from the read I/O frequency, the load (X) of the entire hierarchical configuration may be calculated using the following equation.

X=X_{P}/c

By the above-mentioned Zipf distribution, the number of sub-LUN (capacity ratio and usage capacity) assigned to each hierarchical component is known. When the total load of the entire hierarchical configuration is known, the load applied to each hierarchical component may be calculated.

the number of sub-LUNs assigned to the high performance component: S₁

the number of sub-LUNs assigned to the medium performance component: S₂

the number of sub-LUNs assigned to the low performance component: S₃

the total usage capacity (in the unit of the number of sub-LUNs): N=S₁+S₂+S₃
LOAD APPLIED TO HIGH PERFORMANCE COMPONENT:

X₁=Σₖ₌₁^{S}^{₁}Xf(k;N)
LOAD APPLIED TO MEDIUM PERFORMANCE COMPONENT:

X₂=Σ_{k=S}_{₁}₊₁^{S}^{₁}^{+S}^{₂}Xf(k;N)
LOAD APPLIED TO LOW PERFORMANCE COMPONENT:

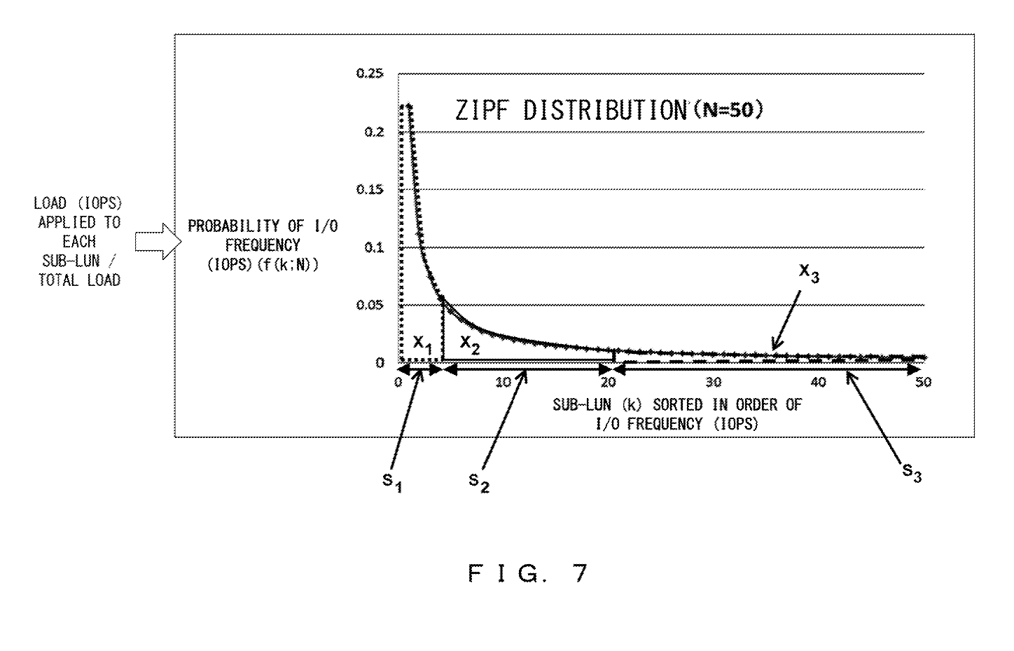

X₃=X−X₁−X₂=Σ_{k=S}_{₁}_{S}_{²}₊₁^{N}Xf(k;N)
the total load applied to the entire hierarchical configuration: X
   The load applied to each hierarchical component corresponds to the area of the region formed by the graph and the X axis as illustrated in FIG. 7.

The calculation of the Zipf distribution requires obtaining the partial sum of a harmonic series.
HARMONIC SERIES

$${\sum }_{n = 1}^{∞} \frac{1}{n} = \frac{1}{1} + \frac{1}{2} + \frac{1}{3} + \frac{1}{4} + \frac{1}{5} + …$$

N-PARTIAL SUM OF HARMONIC SERIES(N-HARMONIC QUANTITIES):

$${H}_{N} = {\sum }_{k = 1}^{N} \frac{1}{k} = \frac{1}{1} + \frac{1}{2} + \frac{1}{3} + … + \frac{1}{N}$$

ZIPF DISTRIBUTION:

$$f ( k ; N ) = \frac{1 / i}{{\sum }_{k = 1}^{N} \frac{1}{k}}$$

In calculating the partial sum of the harmonic series, the calculation is performed at a high speed using the Euler's equation.

$${\sum }_{k = 1}^{N} \frac{1}{k} = log N + γ + {ɛ}_{n}$$

γ: Euler-Mascheroni constant (Euler's gamma)=0.5772156649 . . .
εₙ: VALUE EXPRESSED BY

$${lim}_{n -> ∞} {ɛ}_{n} -> 0$$

THERE IS VIRTUALLY NO PROBLEM IN APPROXIMATION WHEN N IS LARGE TO SOME EXTENT

$${\sum }_{k = 1}^{N} \frac{1}{k} = log N + γ$$

As described above, if the total load of the entire hierarchical configuration is known, the load applied to each hierarchical component may be calculated as illustrated in FIG. 7 and expressed by the following equation. Therefore, the load distribution prediction may be performed from the capacity ratio. In this case, the total part of the Zipf distribution is referred to as a Zipf distribution cumulative value of each hierarchical component.
ZIPF DISTRIBUTION CUMULATIVE VALUE OF HIGH PERFORMANCE COMPONENT:

Z₁=Σₖ₌₁^{S}^{₁}f(k;N)
ZIPF DISTRIBUTION CUMULATIVE VALUE OF MEDIUM PERFORMANCE COMPONENT:

Z₂=Σ_{k=S}_{₁}₊₁^{S}^{₁}^{+S}^{₂}f(k;N)
ZIPF DISTRIBUTION CUMULATIVE VALUE OF LOW PERFORMANCE COMPONENT:

Z₃=Σ_{k=S}_{₁}_{+S}_{₂}₊₁^{N}f(k;N)
the load applied to the high performance component: X₁=XZ₁
the load applied to the medium performance component: X₂=XZ₂
the load applied to the low performance component: X₃=XZ₃=X(1−Z₁−Z₂)

The equation of the Zipf distribution cumulative value of each hierarchical component is transformed as described below and the computational complexity is reduced.

$${Z}_{1} = {\sum }_{k = 1}^{{S}_{1}} f ( k ; N ) = {\sum }_{k = 1}^{{S}_{1}} \frac{1 / k}{{\sum }_{n = 1}^{N} 1 / n} = \frac{{\sum }_{k = 1}^{{S}_{1}} 1 / k}{{\sum }_{n = 1}^{N} 1 / n} = \frac{ln {S}_{1} + γ}{ln N + γ}$$

$${Z}_{2} = {\sum }_{k = {S}_{1} + 1}^{{S}_{1} + {S}_{2}} f ( k ; N ) = {\sum }_{k = 1}^{{S}_{1} + {S}_{2}} f ( k ; N ) - {\sum }_{k = 1}^{{S}_{1}} f ( k ; N ) = {\sum }_{k = 1}^{{S}_{1} + {S}_{2}} f ( k ; N ) - {Z}_{1}$$

$${Z}_{3} = {\sum }_{k = {S}_{1} + {S}_{2} + 1}^{N} f ( k ; N ) = {\sum }_{k = 1}^{N} f ( k ; N ) - {\sum }_{k = 1}^{{S}_{1} + {S}_{2}} f ( k ; N ) = 1 - {\sum }_{k = 1}^{{S}_{1} + {S}_{2}} f ( k ; N )$$

As described below, the Zipf distribution cumulative value for the high performance component and the medium performance component is used.

$${Z}_{12} = {\sum }_{k = 1}^{{S}_{1} + {S}_{2}} f ( k ; N ) = {\sum }_{k = 1}^{{S}_{1} + {S}_{2}} \frac{1 / k}{{\sum }_{n = 1}^{N} 1 / n} = \frac{{\sum }_{k = 1}^{{S}_{1} + {S}_{2}} 1 / k}{{\sum }_{n = 1}^{N} 1 / n} = \frac{ln ( {S}_{1} + {S}_{2} ) + γ}{ln N + γ}$$

$${Z}_{2} = {Z}_{12} - {Z}_{1}$$

$${Z}_{3} = 1 - {Z}_{12}$$

As described above, the load distribution prediction may be performed for each hierarchical component using the capacity ratio and the usage capacity from the load (X) relating to the entire hierarchical configuration. The Zipf distribution cumulative value Z₁ for the high performance component and the Zipf distribution cumulative value Z₁₂ for the high performance component and the medium performance component are obtained from the usage capacity N of the sub-LUN unit, the assignment capacity S₁ of the high performance component, and the assignment capacity S₂ of the medium performance component. Z and Z₃ are obtained from Z₁ and Z₁. By the XZ₁, XZ₂, and XZ₃, the load for each hierarchical component (I/O frequency) is obtained.

When the load applied to the entire hierarchical configuration is multiplied by the Zipf distribution cumulative value of each hierarchical component, the load applied to each hierarchical component may be obtained. Therefore, it is known that the Zipf distribution cumulative value of each hierarchical component is the ratio of the load for each hierarchical component.

In the case of the capacity optimization threshold, the capacity ratio of the hierarchical volume is equal to the logical capacity of each hierarchical component. Assume that the logical capacity of each hierarchical component is listed below.
the logical capacity of the high performance component: L₁
the logical capacity of the medium performance component: L₂
the logical capacity of the low performance component: L₃

The capacity rate threshold in this case may be calculated by the following calculation.
the capacity ratio of the high performance component: R₁=L₁/(L₁+L₂+L₃)
the capacity ratio of the medium performance component: R₂=L₂/(L₁+L₂+L₁)
the capacity ratio of the low performance component: R₃=L₃/(L₂+L₂+L₃)

If the usage capacity (N) of the sub-LUN unit is known, the number of sub-LUNs assigned to each hierarchical component may be calculated.
the number of sub-LUNs assigned to the high performance component: S₁=NR₁
the number of sub-LUNs assigned to the medium performance component: S₂=NR₂
the number of sub-LUNs assigned to the low performance component: S₃=NR₃
These values are practically rounded into integers.

Next, the capacity ratio for the performance optimization is calculated. The performance of the high performance component (SSD) is much higher than those of the medium performance component and the low performance component. Therefore, it is assumed that the high performance component has infinitely high performance. In this case, since the entire performance is higher when the capacity is assigned in order from the higher performance component, it is assumed that the assigned capacity of the high performance component is equal to the logical capacity (use rate is 100%). Since it is assume that the frequency of data accessed by a user is in accordance with the Zipf distribution, no infinite load is applied to the high performance component in this case.

The maximum load (I/O frequency) which satisfies the response condition in the medium performance component and the low performance component may be calculated by the equation (1).
the maximum I/O frequency which satisfies the response condition in the medium performance component: X_{N2}
the maximum I/O frequency which satisfies the response condition in the low performance component: X_{N3}

As described above, since the condition of the average response is applied to the medium performance component, the assignment is not performed from the medium performance component as the high performance component. If the assignment is performed in order from the medium performance component on a priority basis, the load is excessively applied on the medium performance component, and the average response in the medium performance component may exceed the maximum response. Therefore, it is necessary to perform the assignment of the capacity to satisfy the response condition of both the medium performance component and the low performance component by assigning the capacity to some extent to the low performance component.

Assume that the performance optimization is realized by maintaining the ratio of the load which is distributed to each of the medium performance component and the low performance component equal to the ratio of each maximum load. Thus, the capacity ratio which satisfies the response condition in each hierarchical component may be calculated. “X” indicates the load applied to the entire hierarchical configuration, and “X₁” indicates the load applied to the high performance component. The X₂ which is applied to the medium performance component is expressed as follows.

X₂={(X_{M2}/(X_{M2}+X_{M3})}(X−X₁)

The load applied to the medium performance component is calculated as described above, but the Zipf distribution cumulative value indicates the ratio of the load in each hierarchical component. Therefore, the equation for calculating the load which is applied to the medium performance component holds true also by replacing the load with a Zipf cumulative value.

Z₂={(X_{M2}/(X_{M2}+X_{M3})}(1−Z₁)

Described below is a concrete calculation method.
the total number of sub-LUNs obtained from the usage capacity: N
the number of sub-LUNs obtained from the logical capacity of the high performance component: S₁
the Zipf distribution cumulative value of the high performance component: Z₁=(1n S₁+γ)/(1n N+γ)
The Zipf distribution cumulative value of the medium performance component and the low performance component equals the value obtained by subtracting the Zipf distribution cumulative value of the high performance component from the total: Z₂₃=1−Z₃
the maximum I/O frequency of the medium performance component: X_{M2}
the maximum I/O frequency of the low performance component X_{M3}
Assume that the Zipf distribution cumulative value of the medium performance component is the value obtained by dividing the Z₂₃ above by the ratio of the maximum I/O frequency: Z₂: Z₂=(1−Z₁) {X_{M2}/(X_{M2}+X_{M3})}

Furthermore, the equation is derived as follows with the number of sub-LUNs assigned to the medium performance component set as S₂.

$${Z}_{2} = {Z}_{12} - {Z}_{1} = \frac{ln ( {S}_{1} + {S}_{2} ) + γ}{ln N + γ} - \frac{ln {S}_{1} + γ}{ln N + γ} = \frac{ln ( {S}_{1} + {S}_{2} ) - ln {S}_{1}}{ln N + γ}$$

The equation above is solved for S₂, thereby performing the operation.

$${S}_{2} = exp ( {Z}_{2} ( ln N + γ ) + ln {S}_{1} ) - {S}_{1} = exp ( {Z}_{2} ( ln N + γ ) + ln {S}_{1} + γ - γ ) - {S}_{1} = exp ( ( {Z}_{2} + \frac{ln {S}_{1} + γ}{ln N + γ} ) ( ln N + γ ) - γ ) - {S}_{1} = exp ( ( {Z}_{1} + {Z}_{2} ) ( ln N + γ ) - γ ) - {S}_{1}$$

the number of sub-LUNs assigned to the low performance component: S₃=N−S₁−S₂

Described next is the calculation of the maximum load and set load threshold. For the capacity optimization and the set load threshold, the capacity ratio assigned to each hierarchical component is determined by the logical capacity of each hierarchical component. Therefore, the capacity rate threshold is independent of the load. Although the I/O frequency threshold depends on the load, the capacity ratio is fixed as described above, and the following calculation is performed. Assume that the number of sub-LUNs assigned to the high performance component, the medium performance component, and the low performance component are respectively S₁, S₂, and S₃ (usage capacity N in the sub-LUN unit=S₁+S₂+S₃).

The operator of the program according to the first embodiment assumes that the load to be applied to the hierarchical storage device has been measured in advance by a user, and the value is input as a set load (X₁).

Since the I/O frequency threshold to be acquired is the I/O frequency in the S₁-th and (S₁+S₂)-th sub-LUNs, the I/O frequency threshold (τ₁₂) between the high performance component and the medium performance component and the I/O frequency threshold (τ₂₃) between the medium performance component and the low performance component may be calculated by the following equation according to the Zipf distribution.

$${τ}_{12} = \frac{1}{ln N + γ} \frac{{X}_{I}}{{S}_{1}}$$

$${τ}_{23} = \frac{1}{ln N + γ} \frac{{X}_{I}}{{S}_{1} + {S}_{2}}$$

In the case of the capacity optimization and maximum load threshold, it is first necessary to calculate the maximum load which satisfies the response condition of each hierarchical component and is to be applied to the entire hierarchical configuration. As in the case of calculating the performance optimization threshold, it is assumed that the high performance component has infinite performance, and the maximum load which satisfies the response condition in the medium performance component and the low performance component is calculated by the equation (1).
the maximum I/O frequency which satisfies the response condition in the medium performance component: X_{M2}
the maximum I/O frequency which satisfies the response condition in the low performance component: X_{M3}

Since the number of sub-LUNs assigned to each hierarchical component is known, the Zipf distribution cumulative value of each hierarchical component may be calculated.
the Zipf distribution cumulative value of the high performance component: Z₁=(1n S₁+γ)/(1n N+γ)
the Zipf distribution cumulative value for the high performance component and the medium performance component: Z₁₂={(1n S₁+S₂)+γ/(1n N+γ)
the Zipf distribution cumulative value of the medium performance component: Z₂−Z₁₂−Z₁
the Zipf distribution cumulative value of the low performance component: Z₃=1−Z₁₂

For each of the medium performance component and the low performance component, the maximum I/O frequency is divided by the Zipf distribution cumulative value, and the smaller result is set as the maximum load (X_{M}).

$${X}_{M} = MIN ( \frac{{X}_{M 2}}{{Z}_{2}} , \frac{{X}_{M 2}}{{Z}_{3}} )$$

For the maximum load, the I/O frequency threshold is calculated as with the case of the set load.

$${τ}_{12} = \frac{1}{ln N + γ} \frac{{X}_{M}}{{S}_{1}}$$

$${τ}_{23} = \frac{1}{ln N + γ} \frac{{X}_{M}}{{S}_{1} + {S}_{2}}$$

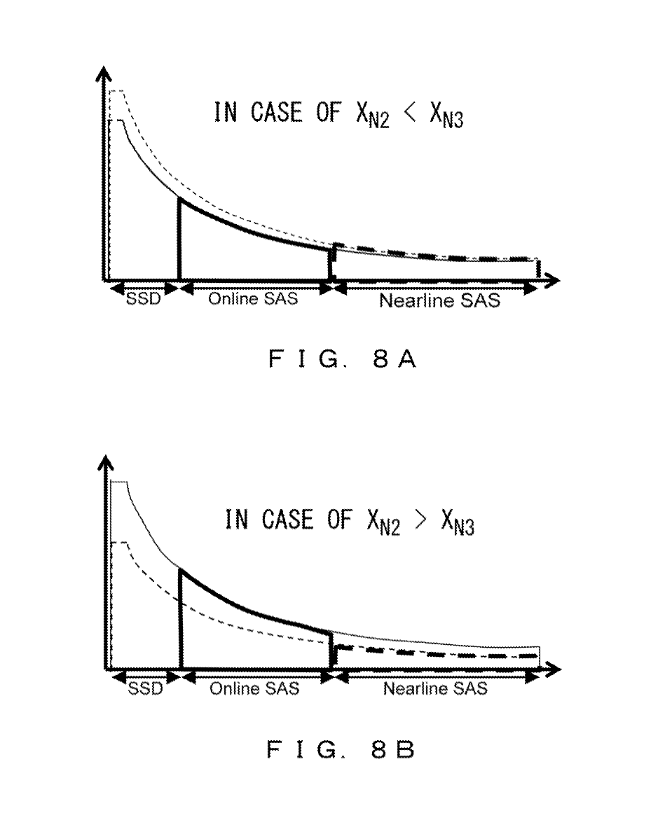

The idea of the method of calculating the maximum load is described below with reference to FIGS. 8A and 8B. The value obtained by dividing each Zipf distribution cumulative value from the maximum I/O frequency of the medium performance component and the low performance component corresponds to the entire performance calculated from the performance of each hierarchical component. In FIGS. 8A and 8B, the area enclosed by the bold line indicates the maximum I/O frequency of the medium performance component, and the area enclosed by the thin line indicates the entire load (X_{M2}) calculated from the performance of the medium performance component. Similarly, the area enclosed by the bold line indicates the maximum I/O frequency of the low performance component, and the area enclosed by the thin line indicates the entire load (X_{M3}) calculated from the performance of the low performance component.

By setting the minimum values of the X_{N2} and X_{N3} as the maximum loads, the maximum load which satisfies the response condition in all hierarchical components may be calculated.

As described above, the capacity ratio (the number of sub-LUNs assigned from each hierarchical component) in the case of the performance optimization is independent of the load relating to the hierarchical configuration. The number of sub-LUNs assigned from each hierarchical component is determined by the I/O frequency calculated from the usage capacity, the physical configuration of each hierarchical component, and the maximum response. Therefore, the capacity rate threshold independent of the load is uniquely calculated for the hierarchical configuration.

The I/O frequency threshold in the case of the performance optimization and the set load may be similarly calculated from the above-mentioned number of number of sub-LUNs. The I/O frequency threshold in the case of the performance optimization and maximum load may also be calculated by calculating the Zipf distribution cumulative value of each hierarchical component from the above-mentioned number of sub-LUNs, calculating the entire maximum load as in the case of the capacity optimization and the maximum load, and calculating the I/O frequency threshold therefrom.

Described below is the performance model of the equation (1) above. The reasons for the change of the processing performance of the RAID system in the storage system are a disk characteristic, a RAID configuration, a volume configuration, a work load characteristic. The disk characteristic may be a disk capacity, and the number of revolutions of a disk [rpm](=seek time). The number of revolutions of a disk [rpm] is regarded as a disk constant (D) as described later.

As the RAID configuration, a RAID level and a RAID member are considered. The RAID member is regarded as a RAID rank (R).

The volume configuration has an available volume ratio (v). The available volume ratio (v) refers to the capacity of the actual data storage with respect to the capacity of the entire RAID group configured by certain RAID levels and RAID members. Assuming that the disk capacity is C, the capacity of the RAID group is expressed by CR. Therefore, assuming that the available capacity is L, the equation v=L/CR holds true.

The work load characteristics may be an I/O frequency, an average I/O data size (=average block size), and a read-to-write ratio.

The I/O frequency indicates the number of I/O SSD per unit time (second). The I/O frequency for count of a read command is referred to as a read I/O frequency. The I/O frequency for count of a write command is referred to as a write I/O frequency. The total I/O frequency is expressed as “X”, read I/O frequency as “X_{R}”, and write I/O frequency as “X_{R}”.

The read-to-write ratio is considered as a read rate (c) (c=X_{R}/X).

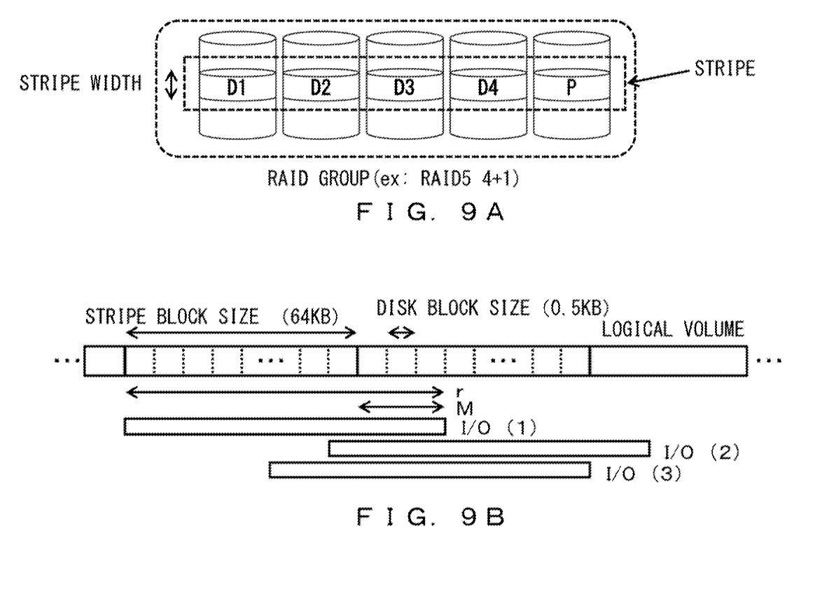

The average I/O size (=average block size) refers to the data size transmitted in one request (I/O). The average I/O size is considered as the expectation value (E_{R}) of the number of stripe blocks in the range of a read, and the expectation value (E_{W}) of the number of stripe blocks in the range of a write. The expectation value of the number of stripe blocks in the range of a read is described below with reference to FIGS. 9A and 9B.

FIGS. 9A and 9B are explanatory views of an expectation value of the number of stripe blocks in the range of a read according to the first embodiment. A different block size derives a different performance of the RAID. That is, the larger the block is, the larger amount of data accesses a disk, and the response time increases. However, when only the disk unit measures the response time, the influence does not appear on the response performance. Practically, it is recognized that the change in time taken to perform a read or a write from a disk hardly affects the response depending on the difference in block size.

However, when the response time is measured by the RAID, the response performance becomes worse with an increasing block size. It is considered that when I/O is performed in the range of a stripe block, the I/O is divided in the stripe block unit, thereby accessing a plurality of disks and degrading the performance.

As illustrated in FIG. 9A, the disk is logically divided in the stripe block unit, a stripe is generated in the stripe block (D1 through D4) at the same position with respect to each disk of the RAID group, and a parity (P) is generated to maintain the redundancy in the unit.

The same disk (same capacity) is used in a RAID group. In the case of the RAID 5 and the RAID 6, the disk storing the parity in each stripe depends on the stripe.

That is, the block size does not affect the performance, but the number of disks to be accessed affects the performance. It is estimated that the number of disks on which I/O is performed is equal to the number of stripe blocks in the range of the I/O, and the expectation value is calculated.

Described below is the method of calculating the expectation value of the number of stripe blocks in the range of the I/O. A stripe width (=size of a stripe block) depends of the raid to be used. In the first embodiment, it is assumed that the stripe width (=size of a stripe block) is 64 K bytes (KB), and the disk block size is 0.5 KB. The disk block size is the size of the basic unit of the data to be stored in a disk. The block size in all I/O is a multiple of an integer of a disk block size. Although the block size issued from a user (application program) is an optional size, any system is shaped into an integral multiple of a disk block size depending on the file system used in an operating system (OS). Since an average value of a block size is used in the first embodiment, the average value may be other than an integral multiple of the disk block size, but is larger than the value of the disk block size. In the first embodiment, it is assumed that the average block size is an integral multiple of the disk block size for convenience of explanation below.

The average block size is expressed as “r” [KB]. When the offset of I/O (the leading address of the area to be accessed) refers to the boundary of a stripe block, the block size M in the final stripe block to be accessed is expressed by the following equation.

M=((r−0.5)mod 64)+0.5

The smallest number N of stripe blocks accessed by the I/O is expressed by the following equation.

N=(r−M+64)/64

The expectation value E of the number of stripe blocks in the range of the I/O is expressed by the following equation.

E=(N+1)(2M−1)/128+N(128−2M+1)/128

The above-mentioned expectation value is calculated on the average block size of each of a read and a write.
the expectation value (E_{R}) of the number of stripe blocks in the range of a read
the expectation value (E_{W}) of the number of stripe blocks in the range of a write

Consider the case (case (1) in FIG. 9B) where the offset of I/O is the same as the boundary of the stripe block. In this case, assume that the size to be accessed in the final stripe block to be accessed is M. In this case, the number of stripe blocks to be accessed by I/O is the minimum value.

Next, from the case (1), consider that the offset is shifted by a disk block size, and is transferred to the position just before the next boundary (case (2) in FIG. 98). Since there are 128 disk blocks in the stripe block, there are 128 variations of offset of I/O. The 128 variations of offset of I/O refer to all states of the number of stripe blocks in the range of the I/O.

Considering all conditions above, when the number in the range in the case (1) is N, it is known that at most N+1 stripe blocks are in the range of the I/O. Therefore, in the 128 variations, the respective variations may be counted for the cases in which the number of stripe blocks in the range of the I/O is N and N+1.

The number is N from the case (1) to the case where the final I/O overlaps the boundary of the stripe block (the case (3) in FIG. 9B), and is N+1 from the case (3) to the case (2). In the case (2), the size in which the (N+1)-th stripe block is accessed is M−0.5 [KB]. When the size is converted into the number of disk blocks, it is 2M−1. Therefore, the probability that the number of the stripe blocks in the range of the I/O is N+1 is (2M−1)/128. Therefore, the probability that the number of the stripe blocks in the range of the I/O is N+1 is (2M−1)/128. Therefore, the probability that the number of the stripe blocks in the range of the I/O is N is 1−((2M−1)/128)=(128−2M+1)/128. The probabilityismultiplied by each value (the number of the stripe blocks in the range of the I/O), and the obtained values of the sums is the expectation value of the number of stripe blocks in the range of the I/O.

Described next is the response performance model. The equation of prediction of the random access performance (read response) in one RAID group is expressed by the following equation (1). The parameters A, α, and ε are described later.

$${W}_{R} = \frac{ɛ A ( {e}^{\frac{α}{ɛ} ( {X}_{R} - \frac{ɛ}{α A} )} - 1 ) + ɛ}{{X}_{R}} ( {X}_{R} \geq \frac{ɛ}{α A} ) , \\ {W}_{R} = α A ( {X}_{R} \leq \frac{ɛ}{α A} ) \qquad ( 1 )$$

input information X_{R}: read I/O frequency
output information W_{R}: read response [sec]
parameter A: RAID coefficient
α: disk coefficient
ε: phase change multiplicity
It is assumed that a read results in a 100% cache miss. and a write results in a 100% cache hit. Therefore, when a read response is predicted, the entire response may be predicted.

The RAID coefficient A is determined independent of a disk to be used, but depending on the RAID configuration of a RAID group. In the case of the RAID 5, (A) is expressed by the following equation.

$$A = \frac{1}{2} \frac{R}{{E}_{R} - 0.25} \qquad ( 2 )$$

In the case of the RAID 6, the RAID coefficient (A) is expressed by the following equation 2′).

$$A = \frac{2}{3} \frac{R}{{E}_{R} - 0.25} \qquad ( {2}^{′} )$$

R indicates a RAID rank. E_{R} is an expectation value of the number of segment blocks in the range of a read I/O. Depending on the RAID level, the value of the coefficient A (½ or ⅔), and the value of the numerator is determined by the RAID member (RAID rank). Therefore, it may be mentioned that the RAID coefficient is determined by the RAID configuration.

The disk coefficient (α) is determined independent of the RAID group, but depending on the disk characteristic of a disk to be used. In the case of the RAID 5, the disk coefficient (a) is expressed by the following equation (3).

$$α = \frac{{E}_{R} - 0.5}{R} D \sqrt{\frac{v + 0.5}{1.5}} \qquad ( 3 )$$

In the case of the RAID 6, the disk coefficient (α) is expressed by the following equation (3′).

$$α = \frac{3}{4} \frac{{E}_{R} - 0.5}{R} D \sqrt{\frac{v + 0.5}{1.5}} \qquad ( {3}^{′} )$$

where R indicates a RAID rank, E_{R} indicates an expectation value of the number of segment blocks in the range of the I/O, D indicates a disk constant (a value constant by the type (number of revolutions) of disk independent of the RAID), and v indicates the ratio of the area which practically accesses in the RAID group (0≦v≦1).

Although the disk constant (D) is determined by a disk characteristic such as a disk, the number of revolution, etc., it is difficult to prepare a model for all disks. Therefore, a measured value about the disk to be used is used.

The RAID rank is included in the equation of the disk coefficient. The RAID rank in the present embodiment is derived by a measurement result that the read minimum response does not change although the RAID level changes, and the disk coefficient is set from the disk characteristic independent of the RAID configuration. The disk constant D indicates the performance derived from the original characteristic of the disk such as the number of revolutions.

$$\sqrt{\frac{v + 0.5}{1.5}}$$

The term above corresponds to the term for estimation of the improvement of the disk performance by the probably decreasing seek time by the decrease of the use rate. The seek time may be estimated by (L)^{1/2} with respect to the seek distance L.

Described below is the phase change multiplicity (ε). The phase change multiplicity ε is a value determined by the characteristic of the work load, and is expressed by the following equation of calculation (4).

$$ɛ = \frac{c α A}{a α A + ( 1 - c ) V} \qquad ( 4 )$$

where α indicates a disk coefficient, A indicates a RAID coefficient, c indicates a read ratio (ratio of the read I/O frequency in the I/O frequency) (0≦c≦1), V indicates a virtual write cost (value indicating an estimated internal processing cost of a write).

Since the virtual write cost is a value which changes depending on the read block size (E_{R}), a write block size (E_{W}), and the ratio (v) of the area to be accessed, it is very difficult to generate a model of a work load to be used. Therefore, a restrictive condition is set for the work load to be used, and a measurement value for the restrictive condition is used as a virtual write cost. For example, v=1, E_{R}=E_{W}, the read block size is 8 [KB], 16 [KB], 32 [KB], 48 [KB], and 64 [KB].

Since αA indicates read minimum response, V indicates a virtual write cost, and c indicates a read ratio, it may be mentioned that the value of the phase change multiplicity is determined by the characteristics of a work load.

Described next is the method of evaluating response performance. When a user has an explicit policy on response, that is, when the response of the RAID is to be not more than a specified value to safely operate a system which uses the RAID as storage, the response is directly evaluated for the reference. For example, the RAID is to store goods data and a goods sales site of the Web is to be provided. To perform the processes, the response of the RAID is to be maintained within 0.010 [sec] to prevent a user who uses the goods sales site from feeling a low processing speed. In this case, if the I/O frequency is calculated from the access frequency to an assumed goods sales site, and the calculated response is within 0.010 [sec], then it is assumed that the RAID has satisfactory performance. Otherwise, the I/O frequency in which the response is within 0.010 [sec] is calculated backward, and the access frequency at which the goods sales site may be safely operated is calculated further backward from the I/O frequency, thereby designing the entire goods sales site.

On the other hand, when a user has no explicit policy on the response, the multiplicity is used as an index. The multiplicity is the same as the queue length of a command. The hardware of a system may have the restriction on the maximum value of the queue length. For example, the maximum value of the queue length of the fibre channel host bus adaptor (FCHBA) used for connection of a RAID is restricted to about 30 from the restriction of the internal memory capacity. If the multiplicity is not more than 30 as the maximum value of the queue length, then the evaluation that the operation may be safely performed is made.

Described next in detail is the optimum capacity threshold and optimum performance threshold calculating process according to the first embodiment.

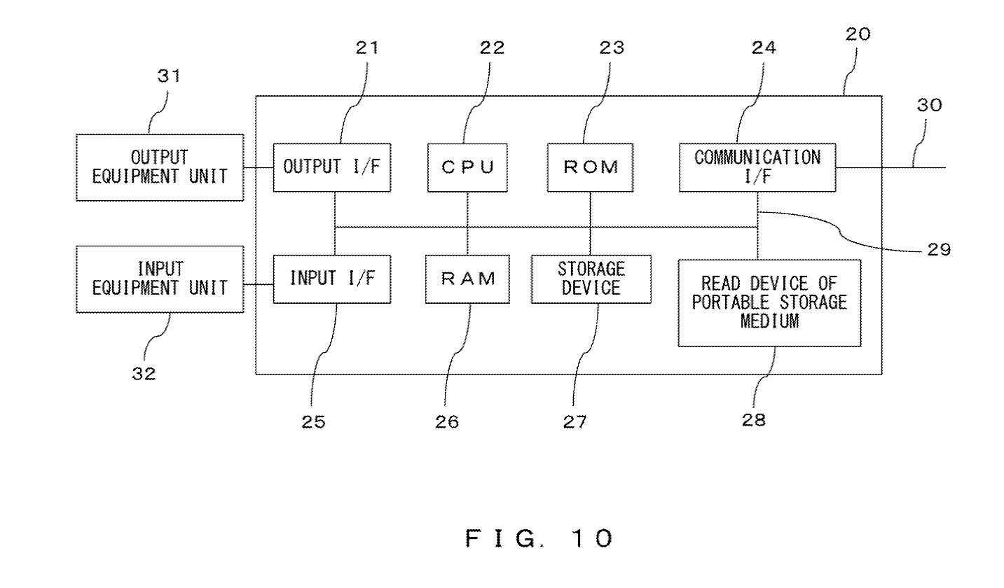

FIG. 10 is a block diagram of the hardware of a computer which performs an optimum capacity threshold and optimum performance threshold calculating process according to the first embodiment. A computer 20 functions as a performance evaluation support device by reading a program for performing the process according to the present embodiment.

The computer 20 includes an output I/F 21, a CPU 22, ROM 23, a communication I/F 24, an input I/F 25, RAM 26, a storage device 27, a read device 28, and a bus 29. The computer 20 may be connected to an output equipment unit 31 and an input equipment unit 32.

The CPU is a central processing unit. The ROM is read only memory. The RAM is random access memory. The I/F is an interface. The output I/F 21, the CPU 22, the ROM 23, the communication I/F 24, the input I/F 25, the RAM 26, the storage device 27, and the read device 28 are connected to the bus 29. The read device 28 is a device for reading a portable storage medium. The output equipment unit 31 is connected to the output I/F 21. The input equipment unit 32 is connected to the input I/F 25.

As the storage device 27, various types of storage devices such as a hard disk drive, a flash memory device, a magnetic disk device, etc. may be used.

The storage device 27 or the ROM 23 stores response performance evaluation support program for realizing the process described later, a parameter used in the evaluating process, a specified threshold, etc.

The CPU 22 is an example of a processor, reads a response performance evaluation support program according to the embodiment stored in the storage device 27 etc., and execute the program.

The response performance evaluation support program according to the embodiment may store may be stored in, for example, the storage device 27 from the program provider through a communication network 30 and the communication I/F 24. The program for realizing the process explained in the first embodiment may be stored in a marketed and distributed portable storage medium. In this case, the portable storage medium is set in the read device 28, and the CPU 22 may read and execute the program. The portable storage medium may be various types of storage media such as CD-ROM, a flexible disk, an optical disk, a magneto optical disk, an IC (integrated circuit) card, a USB (universal serial bus) memory device, etc. The program stored in such a storage medium is read by the read device 28.

The input equipment unit 32 may be a keyboard, a mouse, an electronic camera, a Web camera, a mike, a scanner, a sensor, a tablet, a touch panel, etc. The output equipment unit 31 may be a display, a printer, a speaker, etc. The communication network 30 may be a communication network such as the Internet, a LAN, a WAN, a dedicated line, a cable, a wireless, etc.

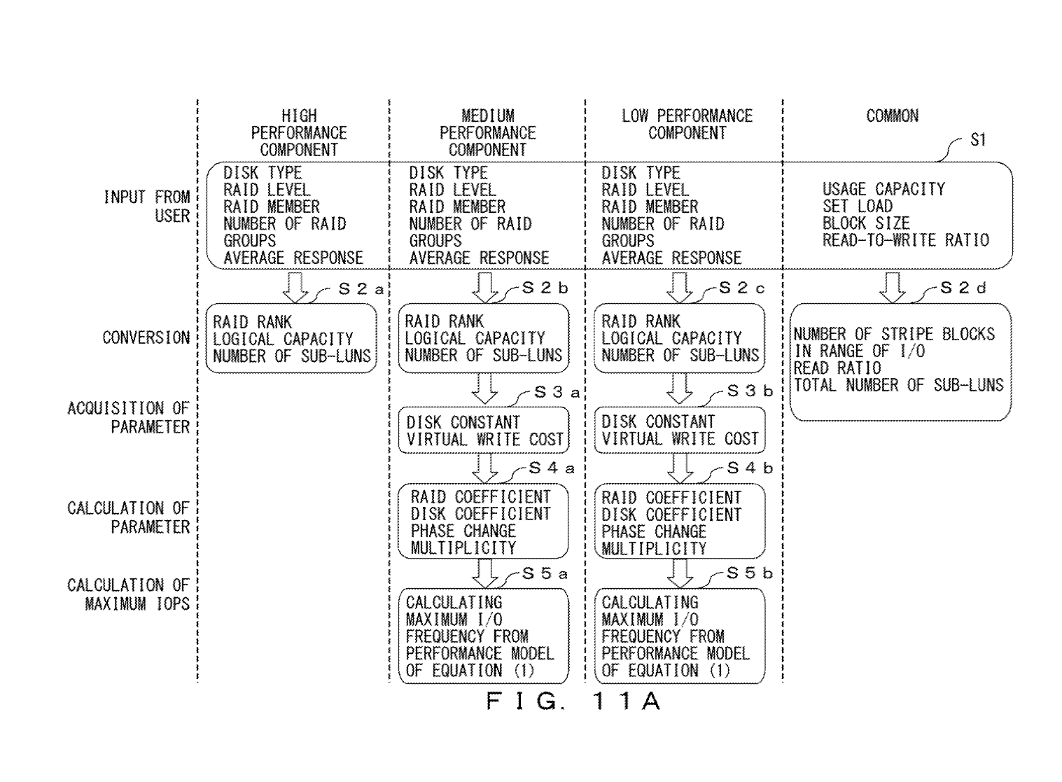

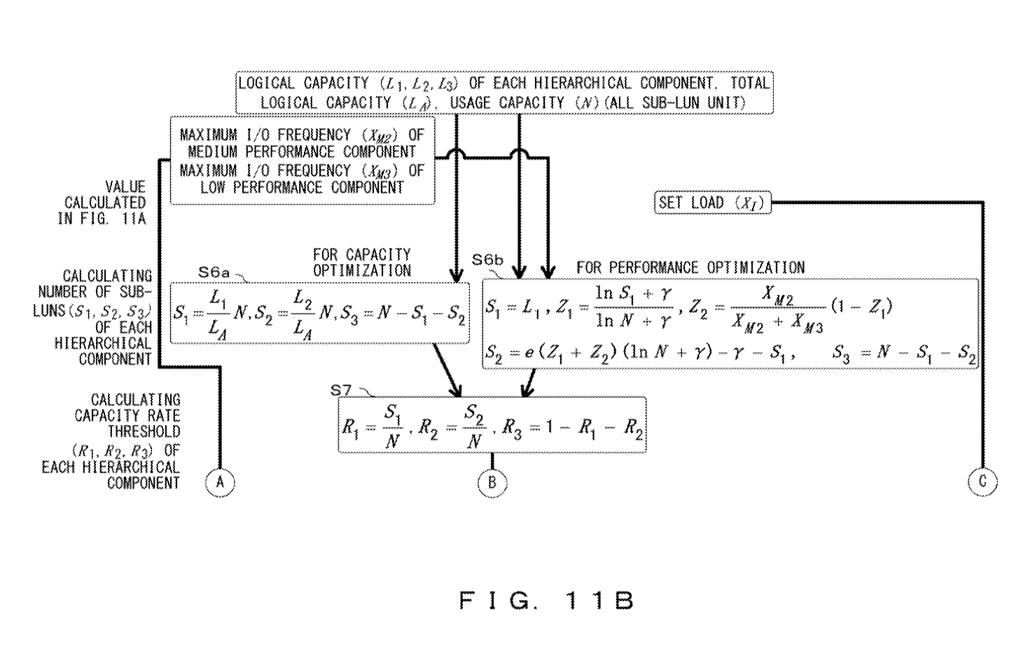

FIGS. 11A through 11C are flowcharts of the optimum capacity threshold and optimum performance threshold calculating process according to the first embodiment. First, the computer 20 accepts the input from a user as listed below (S1).

Type (type, size, number of revolutions, capacity) of disk to be used in each hierarchical component (high performance component, medium performance component, low performance component)

RAID level, RAID member, number of RAID groups in each hierarchical component restriction value of response in each hierarchical component

usage capacity and set load (X₁) assumed for the above-mentioned hierarchical configuration

average block size (average I/O size), read to write ratio

Next, the computer converts the input information from a user into the form which may be easily calculated (S2a through S2d). That is, the computer 20 acquires the read ratio (c) from the read to write ratio. The computer 20 calculates the expectation value (E) of the number of stripe blocks in the range of the I/O. The computer 20 acquires the RAID rank (R) of each hierarchical component from the RAID member of each hierarchical component. The computer 20 calculates the logical capacity of each hierarchical component from the disk capacity, the RAID level, and the RAID rank (R) of each hierarchical component. The computer 20 calculates the number of sub-LUNs (L₁, L₂, L₃) and the number of sub-LUN (L_{A}) of each hierarchical component from the logical capacity of each hierarchical component. The computer 20 converts the usage capacity into the number of sub-LUNs (N).

Next, the computer acquires the parameter used in the performance model of the equation (1) (S3a, S3b). That is, the computer 20 acquires the respective disk constants (D) from the type of the disk of the medium performance component and the low performance component. The computer 20 acquires the virtual write cost (V) of each hierarchical component from the disk constant, the RAID level, and the average block size of the medium performance component and the low performance component. From the system of assigning the capacity of the hierarchical storage, the sub-LUN is assigned from any place of the RAID volume. Therefore, the use ratio (v) of each hierarchical component is set to “1”.

Next, the computer calculates the parameter to be used in the performance model of the equation (1) (S4a, S4b). The computer 20 calculates the RAID coefficient (A) of each hierarchical component from the RAID level, the RAID rank (R), and the expectation value (E) of the number of stripe blocks in the range of the I/O of the medium performance component and the low performance component. The computer 20 calculates the disk coefficient (a) of each hierarchical component from the RAID level, the RAID rank (R), the expectation value (E) of the number of stripe blocks in the range of the I/O, and the disk constant (D) of the medium performance component and the low performance component. The computer 20 calculate the phase change multiplicity (c) from the RAID coefficient (A), the disk coefficient (a), the virtual write cost (V), and the read ratio (c) of the medium performance component and the low performance component.

Next, the computer 20 calculates the maximum I/O frequency of the medium performance component and the low performance component from the performance model of the equation (1) (S5a, S5b). The computer 20 calculates the maximum I/O frequency (X₂) of the medium performance component and the maximum I/O frequency (X₃) of the low performance component by calculating the approximate solution of the inverse function of the performance model equation of the equation (1) from the average response, the RAID coefficient (A), the disk coefficient (α), and the phase change multiplicity (ε) of each hierarchical component.

Next, the computer 20 calculates the capacity rate threshold when the capacity optimization is applied (S6a, S7). In this example, the computer 20 calculates the number of sub-LUNs (S₁, S₂, S₃) for the usage capacity (N) and the capacity ratio (R₁, R₂, R₃) of each hierarchical component from the logical capacity in each hierarchical component.

Next, the computer 20 calculates the Zipf distribution cumulative value in the case of the capacity optimization from the number of sub-LUNs of each of the above-mentioned hierarchical components (S8). In this example, the computer 20 calculates the Zipf distribution cumulative value (Z₁) of the high performance component from the usage capacity (N) and the number of sub-LUNs (S₁) of the high performance component. Furthermore, the computer 20 calculates the sum of the Zipf distribution cumulative values (Z₁₂) of the high and medium performance components from the usage capacity (N), the number of sub-LUNs (S₁) of the high performance component, and the number of sub-LUNs (S₂) of the medium performance component. The computer 20 calculates the Zipf distribution cumulative value (Z₂) of the medium performance component and the Zipf distribution cumulative value (Z₃) of the low performance component using the sum of the Zipf distribution cumulative values (Z₁₂) of the high and medium performance components.

Next, the computer 20 calculates the maximum load for the capacity optimization from the maximum I/O frequency calculated from each hierarchical component (S9). In this example, the computer 20 calculates the total I/O frequency (X_{N2}) estimated from the medium performance component from the maximum I/O frequency (X_{M2}) of the medium performance component and the Zipf distribution cumulative value (Z₂) of the medium performance component. The computer 20 calculates the total I/O frequency (X_{N3}) estimated from the low performance component from the maximum I/O frequency (X_{M3}) of the low performance component and the Zipf distribution cumulative value (Z₃) of the low performance component. The computer 20 sets as the optimum load for the capacity optimization the smaller value between the total I/O frequency (X_{N2}) estimated from the medium performance component and the total I/O frequency (X_{N3}) estimated from the low performance component.

Next, the computer 20 calculates the I/O frequency threshold for the capacity optimization and the set load from the capacity rate threshold and the set load for the capacity optimization (S10). In this example, the computer 20 calculates the I/O frequency threshold (τ₁₂) between the high performance component and the medium performance component by the equation of the Zipf distribution from the usage capacity (N), the number of sub-LUNs (S₁) and the set load (X₁) of the high performance component. The computer 20 calculates the I/O frequency threshold (τ₂₃) between the medium performance component and the low performance component by the equation of the Zipf distribution from the usage capacity (N), the number of sub-LUNs (S₁) of the high performance component, and the number of sub-LUNs (S₂) and the set load (X₁) of the medium performance component.

Next, the computer 20 predicts the load distribution of each hierarchical component for capacity optimization and set load (S11). The computer 20 calculates the load (X₁) applied to the high performance component from the set load (X₂) and the Zipf distribution cumulative value (Z₁) of the high performance component. The computer 20 calculates the load (X₂) applied to the medium performance component from the set load (X₁) and the Zipf distribution cumulative value (Z₂) of the medium performance component. The computer 20 calculates the load (X₃) applied to the low performance component from the set load (X₁) and the Zipf distribution cumulative value (Z₃) of the low performance component.

Next, the computer 20 performs the performance prediction (S12). Assume that the average response (W₁) of the high performance component is a value proportional to the expectation value of the number of stripe blocks in the range of I/O regardless of the load. The average response (W₂) of the medium performance component and the average response (W₃) of the low performance component is calculated using the performance model equation of the equation (1).

Next, the computer 20 calculates the I/O frequency threshold for capacity optimization and maximum load from the capacity rate threshold for capacity optimization and maximum load (S10). In this case, the computer 20 calculates the I/O frequency threshold (τ₁₂) between the high performance component and the medium performance component by the equation of the Zipf distribution from the usage capacity (N), the number of sub-LUNs (S₁) of the high performance component, and the maximum load (X_{M}). The computer 20 calculates the I/O frequency threshold (τ₂₃) between the medium performance component and the low performance component by the equation of the Zipf distribution from the usage capacity (N), the number of sub-LUNs (S₁) of the high performance component, and the number of sub-LUNs (S₂) of the medium performance component and the maximum load (X_{M}).

Next, the computer 20 performs the load distribution prediction of each hierarchical component for capacity optimization and maximum load (S11). The computer 20 calculates the load (X₁) applied to the high performance component from the maximum load (X_{M}) and the Zipf distribution cumulative value (Z₁) of the high performance component. The computer 20 calculates the load (X₂) applied to the medium performance component from the maximum load (X₁) and the Zipf distribution cumulative value (Z₂) of the medium performance component. The computer 20 calculates the load (X₂) applied to the low performance component from the maximum load (X_{M}) and the Zipf distribution cumulative value (Z₃) of the low performance component.

Next, the computer 20 performs the performance prediction for capacity optimization and maximum load (S12). Assume that the average response (W₁) of the high performance component is the value proportional to the expectation value of the number of stripe blocks in the range of I/O. The average response (W₂) of the medium performance component and the average response (W₃) of the low performance component may be calculated using the performance model equation of the equation (1).

Next, the computer 20 calculates the capacity rate threshold for performance optimization (S6b, S7). It is assumed that the number of sub-LUNs (S₁) of the high performance component is equal to the value of the logical capacity (L₁) of the high performance component. The computer 20 calculates the Zipf distribution cumulative value (Z₁) of the high performance component from the usage capacity (N) and the number of sub-LUNs (S₁) of the high performance component.

The sum of the Zipf distribution cumulative values of the medium and low performance components are obtained by subtracting the Zipf distribution cumulative value (Z₁) of the high performance component from the total (“1”). Then, the computer 20 calculates the Zipf distribution cumulative value (Z₂) of the medium performance component by multiplying the value obtained by subtracting the Zipf distribution cumulative value (Z₁) of the high performance component from the total (“1”) by the ratio of the maximum I/O frequency (X_{M2}) of the medium performance component to the maximum I/O frequency (X_{M3}) of the low performance component.

The computer 20 calculates the number of sub-LUNs (S₂) of the medium performance component by the usage capacity (N), the Zipf distribution cumulative value (Z₁) of the high performance component, the Zipf distribution cumulative value (Z₂) of the medium performance component, and the number of sub-LUNs (S₁) of the high performance component. The computer 20 calculates the number of sub-LUNs (S₃) of the low performance component by the usage capacity (N), the number of sub-LUNs (S₁) of the high performance component, and the number of sub-LUNs (S₃) of the low performance component. Based on the results above, the computer 20 calculates the capacity ratio (R₁, R₂, R₃).

Next, the computer 20 calculates the Zipf distribution cumulative value in each hierarchical component for performance optimization from the number of sub-LUNs for performance optimization (S8). In this example, the computer 20 calculates the Zipf distribution cumulative value (Z₁) of the high performance component from the usage capacity (N) and the number of sub-LUNs (S₁) of the high performance component. Furthermore, the computer 20 calculates the sum of the Zipf distribution cumulative values (Z₁₂) of the high and medium performance components from the usage capacity (N), the number of sub-LUN (S₁) of the high performance component, and the number of sub-LUNs (S₂) of the medium performance component. The computer 20 calculates the Zipf distribution cumulative value (Z₂) of the medium performance component and the Zipf distribution cumulative value (Z₃) of the low performance component using the calculated Zipf distribution cumulative value (Z₁) of the high performance component and the sum of the Zipf distribution cumulative values (Z₁₂) of the high and low performance components.

Next, the computer 20 calculates the maximum load for performance optimization from the maximum I/O frequency calculated from each hierarchical component (S9). In this example, the computer 20 calculates the total I/O frequency (X_{N2}) predicted from the medium performance component from the maximum I/O frequency (X_{M2}) of the medium performance component and the Zipf distribution cumulative value (Z₂) of the medium performance component. The computer 20 calculates the total I/O frequency (X_{N3}) predicted from the low performance component from the maximum I/O frequency (X_{N3}) of the low performance component and the Zipf distribution cumulative value (Z₃) of the low performance component. The computer 20 sets as the optimum load for performance optimization the smaller value between the total I/O frequency (X_{N2}) predicted from the medium performance component and the total I/O frequency (X_{N3}) predicted from the low performance component.

Next, the computer 20 calculates the I/O frequency threshold for performance optimization and set load from the capacity rate threshold for performance optimization and set load (S10). In this example, the computer 20 calculates the I/O frequency threshold (τ₁₂) between the high performance component and the low performance component by the equation of the Zipf distribution from the usage capacity (N), the number of sub-LUNs (S₁) of the high performance component, and the set load (X₁). The computer 20 calculates the I/O frequency threshold (τ₂₃) between the medium performance component and the low performance component by the equation of the Zipf distribution from the usage capacity (N), the number of sub-LUNs (S₁) of the high performance component, the number of sub-LUNs (S₂) of the medium performance component, and the set load (X₁).

Next, the computer 20 performs the load distribution prediction of each hierarchical component for performance optimization and set load (S11). The computer 20 calculates the load (X₁) applied to the high performance component from the set load (X₁) and the Zipf distribution cumulative value (Z₁) of the high performance component. The computer 20 calculates the load (X₂) applied to the medium performance component from the set load (X₁) and the Zipf distribution cumulative value (Z₂) of the medium performance component. The computer 20 calculates the load (X₃) applied to the low performance component from the set load (X₁) and the Zipf distribution cumulative value (Z₃) of the low performance component.

Next, the computer 20 performs the performance prediction for performance optimization and set load (S12). It is assumed that the average response (W₁) of the high performance component is proportional to the expectation value of the number of stripe blocks in the range of I/O regardless of the load. The average response (W₂) of the medium performance component and the average response (W₃) of the low performance component may be calculated using the performance model of the equation (1).

Next, the computer 20 calculates the I/O frequency threshold for performance optimization and maximum load from the capacity rate threshold for performance optimization and maximum load (S10). In this case, the computer 20 calculates the I/O frequency threshold (τ₁₂) between the high performance component and the medium performance component by the equation of the Zipf distribution from the usage capacity (N), the number of sub-LUNs (S₁) of the high performance component, and the maximum load (X). The computer 20 calculates the I/O frequency threshold (τ₂₃) between the medium performance component and the low performance component by the equation of the Zipf distribution from the usage capacity (N), the number of sub-LUNs (S₁) of the high performance component, the number of sub-LUNs (S₂) of the medium performance component, and the maximum load (X_{M}).

Next, the computer 20 performs the load distribution prediction of each hierarchical component for performance optimization and maximum load (S11). The computer 20 calculates the load (X₁) applied to the high performance component from the maximum load (X_{M}) and the Zipf distribution cumulative value (Z₁) of the high performance component. The computer 20 calculates the load (X₂) applied to the medium performance component from the maximum load (X_{M}) and the Zipf distribution cumulative value (Z₂) of the medium performance component. The computer 20 calculates the load (X₃) applied to the low performance component from the maximum load (X_{M}) and the Zipf distribution cumulative value (Z₃) of the low performance component.

Next, the computer 20 performs the performance prediction for performance optimization and maximum load (S12). Assume that the average response (W₁) of the high performance component is a value proportional to the expectation value of the number of stripe blocks in the range of I/O regardless of the load. The average response (W₂) of the medium performance component and the average response (W₃) of the low performance component may be calculated using the performance model equation of the equation (1).

Described below is an embodiment of the flowchart illustrated in FIGS. 11A through 11C. The embodiment below is realized by the computer 20 into which the program according to the first embodiment is installed. Assume that the types of the disks which may be loaded into the hierarchical storage are listed below.

SSD 2.5 [inch] 100 [GB], 200 [GB], 400 [GB]

SSD 3.5 [inch] 100 [GB], 200 [GB], 400 [GB]

Online SAS 3.5 [inch] 15,000 [rpm] 300 [GB], 450 [GB], 600 [GB]

Online SAS 2.5 [inch] 15,000 [rpm] 300 [GB]

Online SAS 2.5 [inch] 10,000 [rpm] 300 [GB], 450 [GB], 600 [GB], 900 [GB]

Nearline SAS 3.5 [inch] 7,200 [rpm] 1 [TB], 2 [TB], 3 [TB]

Nearline SAS 2.5 [inch] 7,200 [rpm] 1 [TB]

Since the number of revolutions of the Online SAS disk and the Nearline SAS disk come in three variations, the disk constant is measured for each disk.

Disk constant (D₁) of the disk of 15,000 [rpm]=0.017

Disk constant (D₂) of the disk of 10,000 [rpm]=0.021

Disk constant (D₃) of the disk of 72,000 [rpm]=0.037

Next, the work load corresponding to the performance evaluation support program is limited, that is, the restrictive condition is set. The first embodiment does not correspond to sequential access, but corresponds to random access. As described above, the random access and read processing is the condition of a 100% cache miss, and write processing is the condition of a 100% cache hit. Since the conditions refer to the worst performance of the RAID in the normal operation, it is considered that the restrictions are significant as the evaluation of the performance.

Furthermore, it is assumed that the average read block size is equal to the average write block size. That is, the average block size=average read block size=average write block size.

A representative value of the average block size may be, for example, 8 [KB], 16 [KB], 32 [KB], or 64 [KB]. A user may select the value closest to any of the representative values.

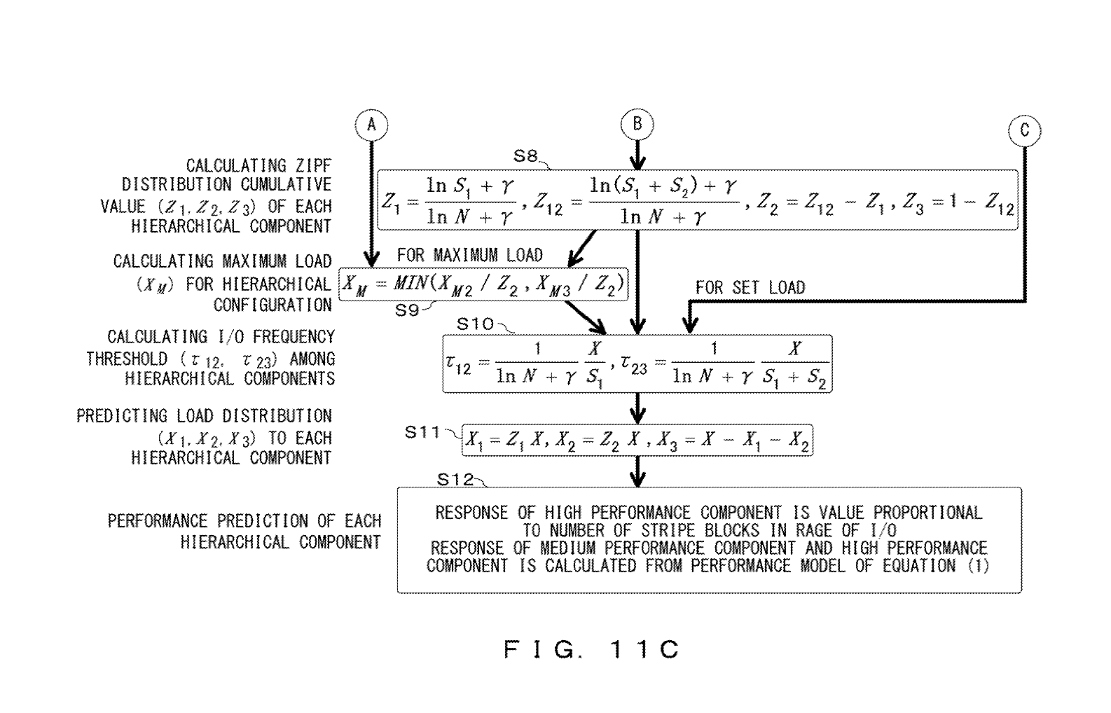

The virtual write cost (V) corresponding to the restrictive conditions above is measured. FIG. 12 illustrates the results of the measurement of the virtual write cost (V) for each RAID level and for each block size of the three disks above.

In this case, the write response (Ww) is also measured. Since it is assumed that the write processing incurs a 100% cache hit, it is assumed that substantially the same value is obtained in all cases. In the first embodiment, it is assumed that the write response (W_{W})=0.000275 [sec].

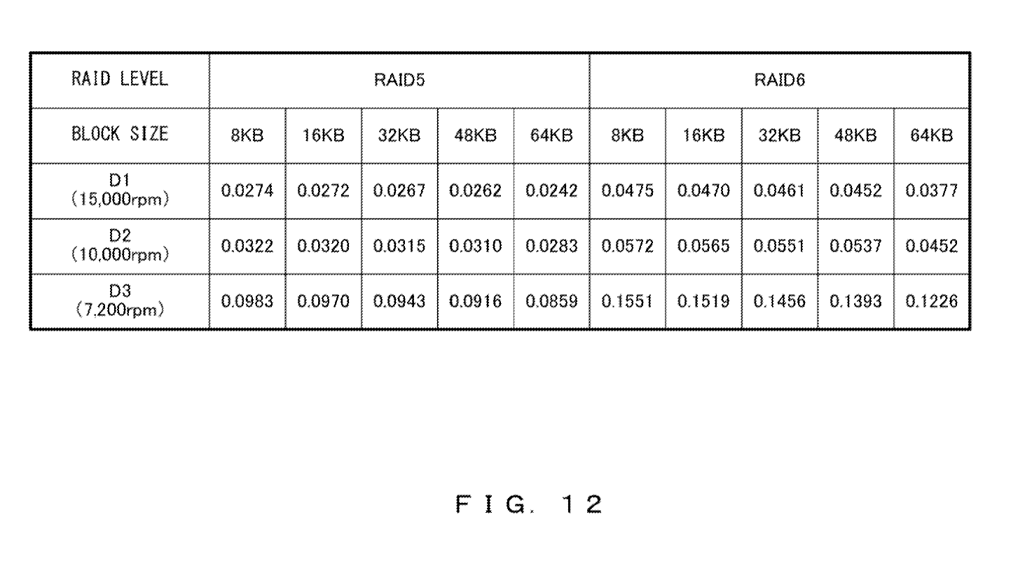

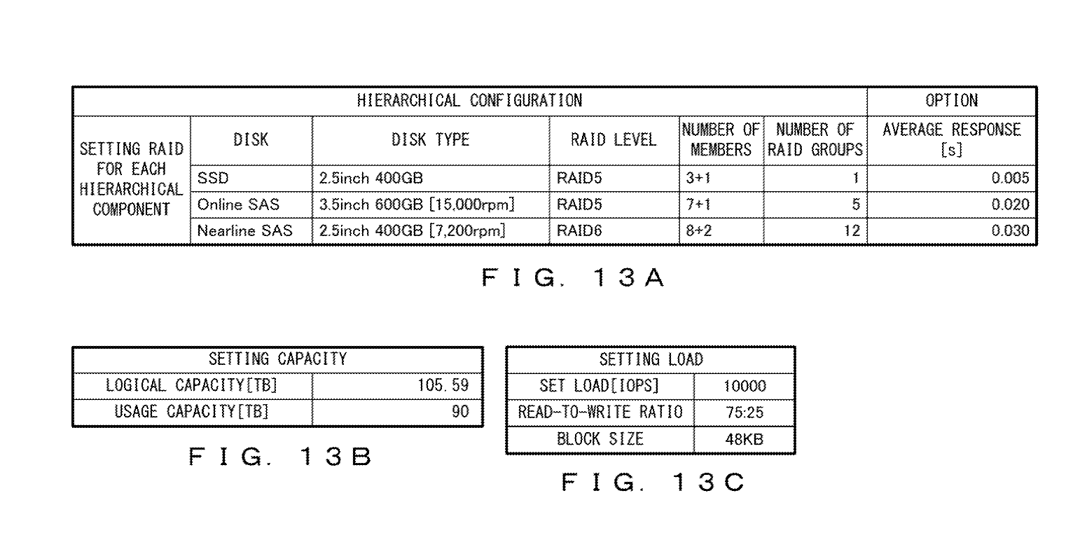

Described next is S1. FIGS. 13A through 13C are examples of the input screen according to the first embodiment. FIG. 13A illustrates an input screen for input of a hierarchical configuration. FIG. 13B illustrates an input screen for input of a setting of a capacity. FIG. 13C is an input screen for input of a setting of a load. Assume an example of the input as illustrated in FIGS. 13A through 13C.

high performance component: 2.5 [inch] SSD 400 [GB], RAID 5 3+1, RAID number of groups 1, average response 0.005 [sec]

medium performance component: 3.5 [inch] Online SAS 15,000 [rpm] 600 (GB), RAID 5 7+1, RAID number of groups 5, average response 0.020 [sec]

low performance component: 2.5 inch Nearline SAS 7,200 [rpm]1 [TB], RAID 6 8+2, RAID number of groups 12, average response 0.030 [sec]

The read-to-write ratio is 75:25, and the average block size is 48 [KB].

The usage capacity is 90 [TB].

The set load is 10,000 [IOPS].

Described next are S2a through S2d. In S2, the computer 20 transforms the input information from a user into a computable form. The high performance component is assigned the RAID rank (R)=3. Since the actual capacity of the 400 [GB] disk is 374,528 [MB], the logical capacity=actual capacity×RAID rank×number of RAID groups=374,528×3×1=1,123,584 [MB].

The medium performance component is assigned the RAID rank (R)=7. Since the actual capacity of 600 GB disk is 559,104 [MB], the logical capacity=actual capacity×RAID rank×number of RAID groups=559,104×7×5=19,567,640 [MB].

The low performance component is assigned the RAID rank (R)=8. Since the actual capacity of 1 [TB] disk is 937,728 [MB], the logical capacity=actual capacity×RAID rank×number of RAID groups=937,728×8×12=90,021,888 [MB].

Assume that the size of the sub-LUN is 1,344 [MB]. In this case, the computer 20 calculates the number of sub-LUNs in each hierarchical component as follows.

The number of sub-LUNs of the high performance component is 1,123,584/1,344=836.

The number of sub-LUNs of the medium performance component is 19,568,640/1,344=14,560.

The number of sub-LUNs of the low performance component is 90,021,888/1,344=66,980.

When the sub-LUN is transferred between hierarchical components, a free capacity is required in the destination hierarchical component. Therefore, the ratio of the free capacity is equally defined as 10%. The computer 20 defines the value obtained by multiplying the number of sub-LUNs in each hierarchical component as the logical capacity of each hierarchical component.

logical capacity (L)) of sub-LUN unit of high performance component: 836×0.9=752

logical capacity (La) of sub-LUN unit of medium performance component: 14,560×0.9=13,104

logical capacity (L₃) of sub-LUN unit of low performance component: 66,980×0.9=60,282

total number of sub-LUNs (L_{A}): 752+13,104+60,282=74,138

The computer 20 converts the usage capacity (90 [TB]) into the number of sub-LUNs (N=90×1,024×1,024/1,344=70,218).

Since the read-to-write ratio is 75:25, the computer 20 calculates the read ratio (c)=0.75.

The computer 20 calculates the expectation value (E) of the number of stripe blocks in the range of I/O.

Assume that the size (stripe length or strike size) of a stripe block is 64 [KB].

average block size: r=48 [KB]

M=((r−0.5) mod 64)+0.5=48

N=(r−M+64)/64=1

E=(N+1){2M−1)/128)+N {(128−2M+1)/128}=1.7422

Since the average block size is equal to the read average block size, the expectation value E_{R} of the number of stripe blocks in the range of a read is equal to the value of E above.

Described next are S3a through S3b, and S4a through S4b. In S3, the computer 20 acquires the parameter used in the performance model of the equation (1) for performance prediction of the medium and low performance components from the input information. In S4, the computer calculates the parameter used in the performance model of the equation (1).

In the medium performance component,

disk constant: D=0.017

virtual write cost: V=0.0262

RAID COEFFICIENT:

$$A = \frac{1}{2} \frac{R}{E - 0.25} = \frac{1}{2} \frac{7}{1.7422 - 0.25} = 2.3455$$

DISK COEFFICIENT:

$$α = \frac{E - 0.5}{R} D \sqrt{\frac{v + 0.5}{1.5}} = \frac{1.7422 - 0.5}{7} * 0.017 = 0.003017$$

PHASE CHANGE MULTIPLICITY:

$$\begin{matrix}ɛ = \frac{c α A}{x α A + ( 1 - c ) v} \\ = \frac{0.75 * 2.3455 * 0.003017}{0.75 * 2.3455 * 0.003017 + 0.25 * 0.0252} \\ = 0.4476\end{matrix}$$

In the low performance component,

disk constant: D=0.037

virtual write cost: V=0.1393

RAID COEFFICIENT:

$$A = \frac{2}{3} \frac{R}{E - 0.25} = \frac{2}{3} \frac{8}{1.7422 - 0.25} = 3.5741$$

DISK COEFFICIENT:

$$α = \frac{3}{4} \frac{E - 0.5}{R} D \sqrt{\frac{v + 0.5}{1.5}} = \frac{3}{4} * \frac{1.7422 - 0.5}{8} * 0.037 = 0.004309$$

PHASE CHANGE MULTIPLICITY:

$$\begin{matrix}ɛ = \frac{c α A}{c α A + ( 1 - c ) V} \\ = \frac{0.75 * 3.5741 * 0.004309}{0.75 * 3.5741 * 0.004309 + 0.25 * 0.1397} \\ = 0.2485\end{matrix}$$

Described next are S5a through S5b. In S5a through S5b, the computer calculates the maximum I/O frequency of each hierarchical component using the performance model of the equation (1) for the performance of the medium and low hierarchical components using the calculated parameter. The performance model of the equation (1) is to obtain the response at any I/O frequency. In the present embodiment, the maximum I/O frequency for an optional response is to be obtained, the inverse function of the performance model of the equation (1) is to be solved. Since the performance model equation of the equation (1) is an equation by which an inverse function is not obtained, it is solved by the system of obtaining an approximate solution provided for a general application software. Although a solution of an inverse function may be obtained using a high class function, it is not used with general application software. In the present embodiment, an approximate solution of an inverse function is obtained by a method of using the solver function of Microsoft Excel (registered trademark). First, the value of the read average response is set in the cell A1. A value of an appropriate I/O frequency is set in the cell B1. The performance model obtained when the cell B1 is an I/O frequency is input as an equation to the cell C1. The conditions of the object cell C1, the maximum value as the target value, the variable cell B1, the restrictive condition cell C1-cell A1 are input to the solver. When the solution is obtained by the solver, the read I/O frequency of the read average response input to the cell A1 is output to B1. Since the calculated read I/O frequency is the read I/O frequency in one RAID, the entire I/O frequency is obtained therefrom.

In the case of the medium performance component, the read response is obtained from the entire average response (0.02 [sec]), the read ratio (0.75), the write response (0.000275). Then, the value of the A1 cell is (0.02−(0.000275*(1−0.75)))/0.75=0.02658. The value of the B1 cell is 1/αA=141,3228. The equation of the C1 cell: “=(0.4476*2.3455*(EXP(0.003017/0.4476*(81−(0.4476/(0.003017*2.3455))))−1)+0.4476)/B1” The result is obtained as 422.6661 by the solver under the above-mentioned conditions. From the maximum I/O frequency=(read I/O frequency of RAID unit)/read ratio×number of RAID groups, the maximum I/O frequency of the entire medium performance component is 422.6661/0.75*5=2817.774.

In the case of the low performance component, the read response is obtained from the entire average response (0.03 [sec]), the read ratio (0.75), the write response (0.000275). Then, the value of the A1 cell is (0.03−(0.000275*(1−0.75)))/0.75=0.03991. The value of the B1 cell is 1/αA=64,9351. The equation of the C1 cell: “=(0.2485*3.5741*(EXP(0.004309/0.2485*(B1−(0.2485/(0.004309*3.5741))))−1)+0.2485)/B1”

The result is obtained as 120.9302 by the solver under the above-mentioned conditions. From the maximum I/O frequency=(read I/O frequency of RAID unit)/read ratio×number of RAID groups, the maximum I/O frequency of the entire low performance component is 120.9802/0.75*12=1934.883.

Described next are S6a and S6b. In S6a and S6b, the computer 20 calculates the capacity rate threshold for each of capacity optimization and performance optimization. First, the computer 20 calculates the number of sub-LUNs of each hierarchical component for each of capacity optimization and performance optimization using the information calculated above.

For capacity optimization, the number of sub-LUNs of each hierarchical component is calculated as described below.

number of sub-LUNs of high performance component: S₁=(L₁/L_{A})N=(752/74,138)*70.218=712.23 . . . ≈712

number of sub-LUNs of medium performance component: S₂=(L₂/L_{A})N=(13,104/74,138)*70.218=12,411,13 . . . ≈12,411

number of sub-LUNs of low performance component: S₃=N−S₁−S₂=70218−712−12,411=57,095

For performance optimization, the number of sub-LUNs of each hierarchical component is calculated as follows.

number of sub-LUNs of high performance component: S₁−L₁=752

Zipf distribution cumulative value of high performance component: Z₁=(1n S₁+γ)/(1n N+γ)=(1n 752+0.5772)/(1n 70.218+0.5772)=0.6134

Zipf distribution cumulative value of medium performance component: Z₂={X_{M2}/(X_{M2}+X_{M3})}(1−Z₁)={2817.774/(2817.774+1934.883)}(1−0.6134)=0.2292

number of sub-LUNs of medium performance component:

S₂=e^{(Z}^{₁}^{+Z}^{₂}^{)(1nN+γ)-γ}−S_{1=10,318.35 . . . ≈10,318}

number of sub-LUNs of low performance component: S₃=N−S₁−S₂=70218−752−10,318=59,148

Described next is S7. In S7, the computer 20 obtains the capacity rate threshold (capacity ratio) in each hierarchical component for each of capacity optimization and performance optimization from the number of sub-LUNs of each hierarchical component.

The capacity rate threshold (capacity ratio) in each hierarchical component for the capacity optimization is calculated as follows.

capacity rate threshold of high performance component: R₁=S₁/N=712/70,218=0.0101

capacity rate threshold of medium performance component: R₂=S₂/N=12,411/70,218=0.1768

capacity rate threshold of low performance component: R₃=1−R₁−R₂=0.8131

the capacity rate threshold (capacity ratio) in each hierarchical component for the performance optimization is calculated as follows.

capacity rate threshold of high performance component: R₁=S₁/N=752/70,218=0.0107

capacity rate threshold of medium performance component: R₂=S₂/N=10,318/70,218=0.1469

capacity rate threshold of low performance component: R₃=1−R₁=R₂=0.8424

Described next is S8. In S8, the computer 20 obtains the Zipf distribution cumulative value in each hierarchical component for each of capacity optimization and performance optimization from the number of sub-LUNs of each hierarchical component.

For the capacity optimization, the Zipf distribution cumulative value in each hierarchical component is calculated as follows.

Zipf distribution cumulative value of high performance component: Z₁=(In S₁+γ)/((1n N+γ)=(1n 712+0.5772)/(1n 70.218+0.5772)=0.6088

sum of Zipf distribution cumulative values of high performance component and medium performance component: Z₁₂=(1n (S₁+S₂)+γ)/(1n N+γ)=(1n (712+12,411)+0.5772)/(1n70.218+0.5772)=0.8571

Zipf distribution accumulation of medium performance component: Z₂=Z₂−Z₁=0.2483

Zipf distribution accumulation of low performance component: Z₃=1−Z₂=0.1429

For the performance optimization, the Zipf distribution cumulative value in each hierarchical component is calculated as follows.

Zipf distribution cumulative value of high performance component: Z₁=(1n S₁+γ)/(1n N+γ)=(1n 752+0.5772)/(1n 70.218+0.5772)=0.6135

sum of Zipf distribution cumulative values of high performance component and medium performance component: Z₁₂=(1n (S₁+S₂) γ)/(1n N+γ)=(1n (752+10,318)+0.5772)/(1n 70.218+0.5772)=0.8426

Zipf distribution accumulation of medium performance component: Z₂=Z₁₂−Z₁=0.2291

Zipf distribution accumulation of low performance component: Z₃=1−Z₁₂=0.1574

Described next is S9. In S9, the computer 20 calculates the maximum load for the hierarchical configuration in each of capacity optimization and performance optimization from the Zipf distribution cumulative value of the medium and low performance components and the maximum I/O frequency.

For the capacity optimization, the maximum load is calculated as follows.

maximum load calculated from the medium performance component: X_{N2}=X_{M2}/Z₂=2817.774/0.2483=11,348.26

maximum load calculated from the low performance component: X_{N3}=Z_{M3}/Z₃==1934.883/0.1429=13,540.12

Since X_{N2}<X_{N3}, the maximum load X_{M}=X_{N2}=11,348.26

For the performance optimization, the maximum load is calculated as follows.

maximum load calculated from the medium performance component: X_{N2}=X_{M2}/Z₂=2817.774/0.2291=12,299.32

maximum load calculated from the low performance component: X_{N3}=X_{M3}/Z₃=1934.883/0.1574=12,292.78

Since X_{N2}>X_{N3}, the maximum load X_{M}=X_{N3}=12,292.78

In the case of the performance optimization, the values of X_{N2} and X_{N3} are very close to each other.

Described next is S10. In S10, the computer 20 calculates four types of I/O frequency thresholds from the set load, the maximum load, and the number of sub-LUNs of each hierarchical component.

The I/O frequency threshold between the hierarchical components in the case of the capacity optimization and the set load is calculated as follows.

I/O frequency threshold between high performance component and medium performance component: τ₁₂={1/(1n N+γ)}(X₁/S₁)=1/(1n 70,218+0.5772)(10,000/712)=1.197

I/O frequency threshold between medium performance component and low performance component: τ₂₃={1/(1n N+γ)}(X₁/(S₁+S₂)) 1/(1n 70,218+0.5772)(10,000/(712+12,411))=0.06493

The I/O frequency threshold between the hierarchical components for capacity optimization and maximum load is calculated as follows.

I/O frequency threshold between high performance component and medium performance component: τ₁₂={1/(1n N+γ)}(X_{M}/S₁)=1/(1n 70,218+0.5772)(11,348.26/712)=1.358

I/O frequency threshold between medium performance component and low performance component: τ₂₃={1/(1n N+γ)}(X_{M}/(S₁+S₂))=1/(1n 70,218+0.5772)(11,348.26/(712+12,411))=0.07368

The I/O frequency threshold between the hierarchical components in the case of the performance optimization and the set load is calculated as follows.

I/O frequency threshold between high performance component and medium performance component: τ₁₂={1/(1n N+γ)}(X₁/S₁)=1/(1n 70,218+0.5772)(10,000/752)=1.133 I/O frequency threshold between medium performance component and low performance component: τ₂₃={1/(1n N+γ)}(X₁/(S₁+S₂))=1/(1n 70,218+0.5772)(10,000/(752+10,318))=0.07797

The I/O frequency threshold between the hierarchical components for performance optimization and maximum load is calculated as follows.

I/O frequency threshold between high performance component and medium performance component: τ₁₂={1/(1n N+γ)}(X_{M}/S₁)=1/(1n 70,218+0.5772) (12,292.78/752)=1.393

I/O frequency threshold between medium performance component and low performance component: τ_{23={}1/(1n N+γ)}(X_{M}/(S₁+S₂))=1/(1n 70,218+0.5772) (12,292.78/(752+10,318))=0.09462

Described next is S11. In S11, the computer 20 calculates four types of loads applied to each hierarchical component.

The load of each hierarchical component for capacity optimization and set load is calculated as follows.

load applied to high performance component: X₁=Z₁ X₁=0.6088*10,000=6,088

load applied to medium performance component: X₂=Z₂ X₁=0.2483*10,000=2,483

load applied to low performance component: X₃=X₁−X₁−X₂=1429

The load of each hierarchical component for capacity optimization and maximum load is calculated as follows.

load applied to high performance component: X₁=Z₁ X_{M}=0.6088*11,348.26=6,908.823

load applied to medium performance component: X₂=Z₂ X_{M}=0.2483*11,348.26=2,817.774
load applied to low performance component: X₃=X_{M}−X₁−X₂=1621.667

The load of each hierarchical component for performance operation and set load is calculated as follows.

load applied to high performance component: X₁=Z₁ X₁=0.6135*10,000=6,135

load applied to medium performance component: X₂=Z₂ X₁=0.2291*10,000=2,291

load applied to low performance component: X₃; X₁−X₁−X₂=1574

The load of each hierarchical component for performance optimization and maximum load is calculated as follows.

load applied to high performance component: X₁=Z₁ X₁=0.6135*12,292.78=7,541.618

load applied to medium performance component: X₂=Z₂ X_{M}=0.2291*12,292.78=2,816.275

load applied to low performance component: X₂=X_{M}−X₁−X₂=1934.883

Described next is S12. In S12, the computer 20 performs four types of response prediction using the performance model of the equation (1). Assume that the response of the high performance component is proportional to the expectation value of the number of stripe blocks in the range of I/O, and the proportion coefficient for [sec] is “1”. Hence, the response of the high performance component is uniformly of 0.0017422 [sec]. Therefore, it is known that, by the performance measurement for a practical device, an approximate value may be acquired in the method above.

The response of the medium performance component in the case of capacity optimization and set load is calculated as follows. As described above, A=2.3455, α=0.003017, ε=0.4476. Although the load is 2483 [IOPS], it is the value obtained by summing up the reads and writes of all RAID groups. Therefore, the value of read I/O frequency: X_{R}=2483*0.75/5=1862.25 per RAID group is used. These values are assigned to the equation of the performance model of the equation (1), thereby obtaining the value of a read response (W_{R}).

$${W}_{R} = \frac{ɛ A ( {e}^{\frac{α}{ɛ} ( {X}_{R} - \frac{ɛ}{α A} )} - 1 ) + ɛ}{{X}_{R}} = 0.02104 [ sec ]$$

The computer 20 obtains an average of the read response (W_{R}) and the write response, and calculates the average response (W).

W=cW_{R}+(1−c)W_{W}=0.575*0.02104+0.25*0.00275=0.01579 [sec]=15.79 [msec]

The response of the low performance component in the case of capacity optimization and set load is calculated as follows. As described above, A=3.5742, α=0.004309, ε=0.2485. Although the load is 1429 [IOPS], it is the value obtained by summing up the reads and writes of all RAID groups. Therefore, the value of read I/O frequency: X_{R}=1429*0.75/12=89.3125 per RAID group is used. These values are assigned to the equation of the performance model of the equation (1), thereby obtaining the value of a read response (W_{R}).

$${W}_{R} = \frac{ɛ A ( {e}^{\frac{α}{ɛ} ( {X}_{R} - \frac{ɛ}{α A} )} - 1 ) + ɛ}{{X}_{R}} = 0.02821 [ sec ]$$

The computer 20 obtains an average of the read response (W_{R}) and the write response, and calculates the average response (W).

W=cW_{R}+(1−c)W_{W=}0.575*0.02821+0.25*0.00275=0.02108 [sec]

The entire average response is calculated by obtaining a virtual average of the response of the high performance component, the medium performance component, and the low performance component using the Zipf distribution cumulative value.

W=Z₁ W₁+Z₂ W₂+Z₃ W₃=0.6088*1.7422+1.7422+0.2483*15.79+0.1429*21.08=0.007994 [sec]

The following results are obtained by similarly performing the calculation also for other three cases. In the case of capacity optimization and set load:

average response of high performance component: 0.0017422 [sec]

average response of medium performance component: 0.01579 [sec]

average response of low performance component: 0.02108 [sec] entire average response: 0.07994 [sec]

In the case of capacity optimization and maximum load:

average response of high performance component: 0.0017422 [sec]

average response of medium performance component: 0.01994 [sec]

average response of low performance component: 0.02408 [sec]

entire average response: 0.09453 [sec]

In the case of performance optimization and set load:

average response of high performance component: 0.0017422 [sec]

average response of medium performance component: 0.01386 [sec]

average response of low performance component: 0.02331 [sec] entire average response: 0.007913 [sec]

In the case of performance optimization and maximum load:

average response of high performance component: 0.0017422 [sec]

average response of medium performance component: 0.01992 [sec]

average response of low performance component: 0.02994 [sec]

entire average response: 0.010345 [sec]

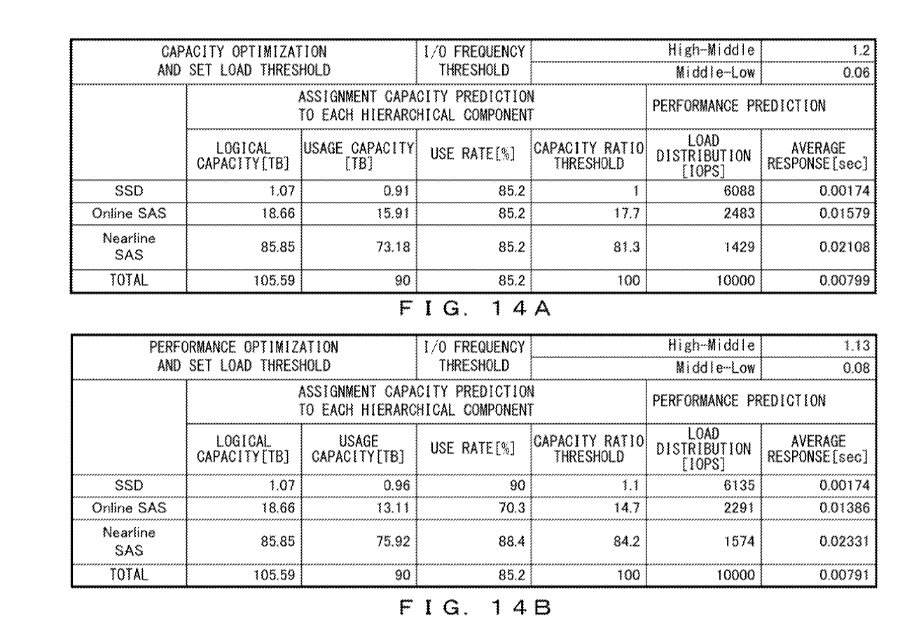

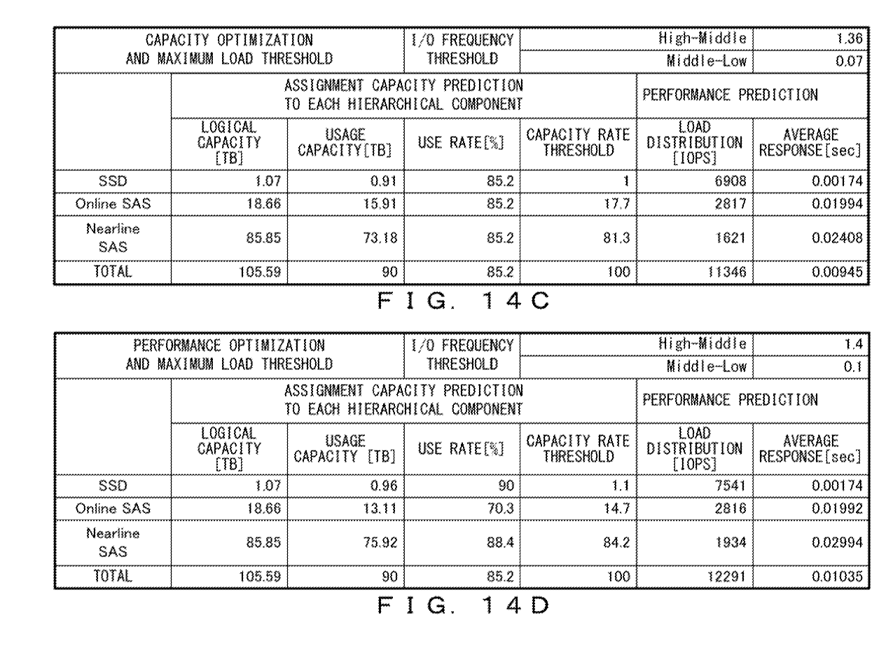

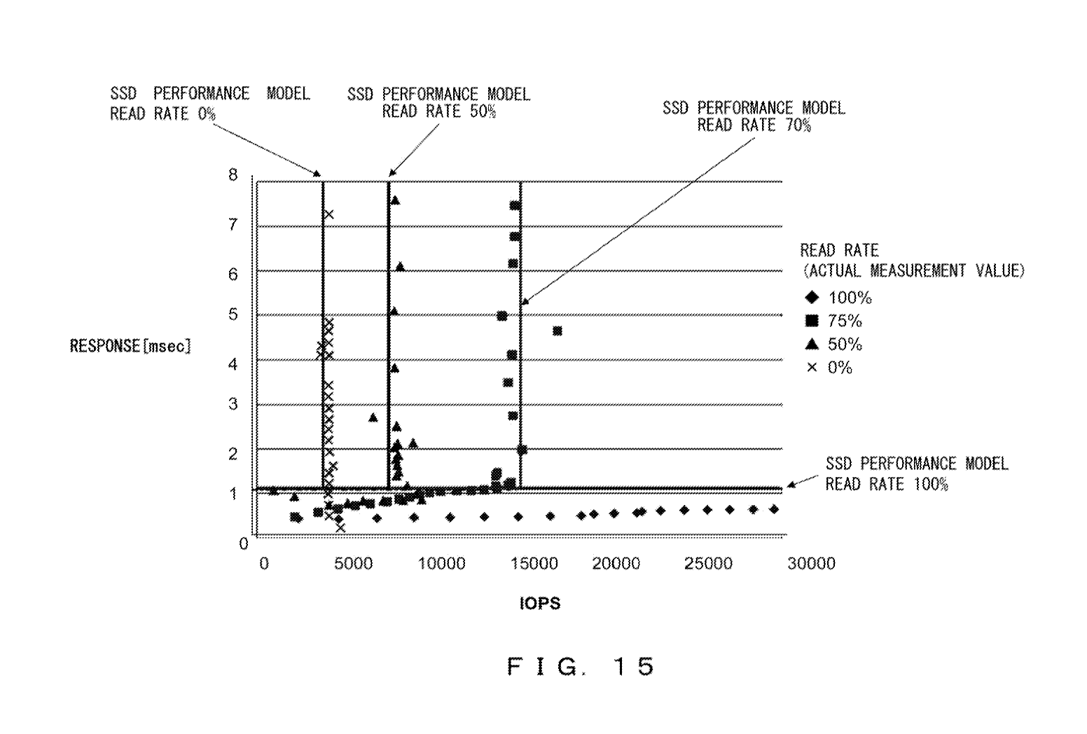

Since the operations are completed, the computer 20 displays the results of the operations as illustrated in interface 14A through 14D. FIG. 14A illustrates the capacity rate threshold, the I/O frequency threshold, and the relating information in the case of capacity optimization and set load. FIG. 14B illustrates the capacity rate threshold, the I/O frequency threshold, and the relating information in the case of performance optimization and set load. FIG. 14C illustrates the capacity rate threshold, the I/O frequency threshold, and the relating information in the case of capacity optimization and maximum load. FIG. 14D illustrates the capacity rate threshold, the I/O frequency threshold, and the relating information in the case of performance optimization and maximum load. Concretely, the computer 20 displays the following information.

For each of capacity optimization and performance optimization;

logical capacity and total logical capacity of each hierarchical component

usage capacity of each hierarchical component and total usage capacity

Use rate of each hierarchical component

capacity rate threshold
for each of set load and maximum load:

I/O frequency threshold,

load applied to each hierarchical component and total load,

average response of each hierarchical component and total average response

Normally, a value (for capacity optimization) to equally assign a usage capacity to a logical capacity is set. However, according to the first embodiment, since a value to maximize the performance of the hierarchical configuration (performance optimization) may be calculated, the need of a user to obtain higher performance may be realized.

Since the I/O frequency threshold depends on the value of a load, the calculation is generally difficult, but the I/O frequency threshold for set load and maximum load may be calculated for each of the cases of the capacity optimization and the performance optimization. In both cases, calculations may be performed on the two virtual points of the maximum I/O frequency for satisfying the response condition in each hierarchical component and the bias of the access with respect to the sub-LUN in accordance with the Zipf distribution.

According to the first embodiment, the hierarchical configuration to be operated and the load which is regarded as the capacity to be used are input, thereby calculating a plurality of thresholds and performing an operation with a threshold optimum for the current embodiment.

Since an optional value may be input as the set load, the set load may exceed the maximum load. When the set load exceeds the maximum load, it indicates that the load is too heavy for the hierarchical configuration and the usage capacity. For example, in FIGS. 14C through 14D, the load (11.346 [IOPS], 12291 [IOPS]) displayed in the total column of the performance prediction exceeds the value (10000 [IOPS]) of the set load. Before practically performing the operation, it may be checked whether or not the entire system is normally operated with the predicted load. If the load is too heavy, a countermeasure may be taken by considering a change in configuration before the operation.

### Second Embodiment

Described in the second embodiment is the load which does not affect the operation when the hierarchical storage system is operated, and the supply of the information as a guide to the optimum usage capacity.

The hierarchical volume has the performance higher than the RAID configured by an Online SAS etc. to use a high-performance storage device such as an SSD etc. In the explanation below, high-performance refers to the capability of performing a process with a short average response time for a request.

However, the performance is not infinitely used even a storage device is a high-performance unit, but there is appropriate and maximum performance which allows an operation to be performed without an abnormal condition of a storage system. To appropriately operate a hierarchical storage, it is preferable to estimate the appropriate performance and use it as an operation index. When the load applied to the hierarchical storage is not less than the appropriate performance, a change is made (by increasing a disk etc.) to obtain a configuration of higher performance.

The higher the ratio of the free capacity of a hierarchical storage to the total capacity is, the higher the performance is. However, when the set free capacity is too large, the amount of stored data is limited. On the other hand, when most of the total capacity is used, the performance does not work. Therefore, there is the appropriate maximum capacity with which the performance works.

To appropriately operate the hierarchical storage, it is preferable that the appropriate capacity is estimated, and use it as an operation index. When the usage capacity for storing data in the hierarchical storage exceeds the appropriate capacity, a change is made to the configuration for a larger capacity (by increasing a disk etc.).

Described below relating to the second embodiment are calculating an appropriate performance and an appropriate capacity, and easily operating the hierarchical storage. The configuration of a hierarchical storage and the restrictive condition of the performance are similar to those explained relating to the first embodiment. In the second embodiment, the Zipf distribution cumulative value and the performance model of the equation (1) which are used in the first embodiment are also used.

Described first are the definitions of the optimum performance and the optimum usage capacity. When the logical capacity is completely used in all hierarchical components with respect to the given hierarchical configuration, the maximum load which satisfies the average response condition of each hierarchical component is defined as the predicted performance, and the predicted performance is set as the optimum performance. Therefore, it is mentioned that the maximum load is the maximum load capable of satisfying the average response condition in all hierarchical components although any load which is not more than the value of the optimum performance is applied to the hierarchical configuration, or although the usage capacity increases to a large extent.

When the usage capacity is decreased while the average response condition of each hierarchical component is satisfied with respect to the given hierarchical configuration, the capacity with which the maximum performance is obtained is referred to as the optimum usage capacity. Therefore, with respect to the hierarchical configuration, when the usage capacity is not less than the optimum usage capacity, it is mentioned that the maximum performance of the hierarchical configuration may be unable to work.

Described below is the method of calculating the optimum performance. As with the first embodiment, the cumulative value of the Zipf distribution refers to the ratio of the distribution of the load to each hierarchical component. Since the logical capacity of each hierarchical component is fixed, the accumulation of the Zipf distribution in each hierarchical component may be calculated. The maximum I/O frequency which satisfies the average response condition of each hierarchical component is calculated as described later. As described in the first embodiment, if the maximum I/O frequency of each hierarchical component is divided by the cumulative value of the Zipf distribution in each hierarchical component, the total I/O frequency is obtained from the performance of each hierarchical component. In the calculated total I/O frequency of each of the hierarchical components, the smallest value is referred to as the optimum performance.

Using the performance model of the equation (1), the maximum I/O frequency may be calculated for the average response of the medium or low performance component.

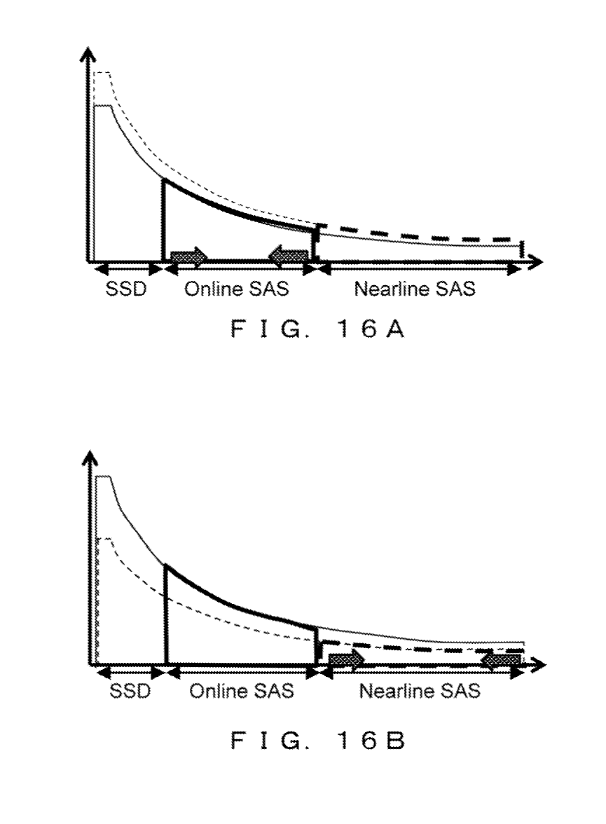

On the other hand, relating to the high performance component, that is, the RAID configured by SSDs, the following performance model is generated for use in calculating the optimum performance. FIG. 15 illustrates the relationship between the I/O frequency for each read ratio with respect to the RAID configured by the SSD and the response time. In FIG. 15, the RAID configured by the SSD has fixed response time up to the maximum I/O frequency as illustrated in FIG. 15 regardless of the read ratio. The response time is proportional to the block size (number of stripe blocks in the range of I/O). The proportion coefficient is set to “1”. The maximum I/O frequency (X_{MC}) with an optional read ratio (c) is expressed by X_{MC}=(1/(1−c))X_{M0} with respect to the maximum I/O frequency (X_{M0}) for the write only. The I/O frequency for the write only is proportional to the RAID rank, and inversely proportional to the block size (expectation value of the number of stripe blocks in the range of I/O). The proportion coefficient is set to “1400”.

As described below, the entire load (predicted performance) is calculated from the maximum I/O frequency which satisfies the average response condition of each hierarchical component. First, as described above relating to the first embodiment, the approximate solution of the inverse function of the performance model equation expressed by the equation (1) is calculated from the average response of each hierarchical component, the RAID coefficient (A), the disk coefficient (u), and the phase change multiplicity (ε). Thus, the maximum I/O frequency (X_{M2}) of the medium performance component, and the maximum I/O frequency (X_{M3}) of the low performance component are calculated. Furthermore, from the SSD performance model above, the maximum I/O frequency (X_{M1}) of the high performance component is calculated.

Next, as explained above relating to the first embodiment, the Zipf distribution cumulative value of each hierarchical component is calculated.

number of sub-LUNs obtained from the logical capacity of the high performance component: S₁

number of sub-LUNs obtained from the logical capacity of the medium performance component: S₂

number of sub-LUNs obtained from the logical capacity of the low performance component: S₃

number of sub-LUNs obtained from the usage capacity: N=S₁+S₂+S₃

Zipf distribution cumulative value of the high performance component: Z₁=(1n S₁+γ)/(1n N+γ)

sum of Zipf distribution cumulative values of the high and medium performance components: Z₁₂={(1n S₁+S₂)+γ}/(1n N+γ)

Zipf distribution cumulative value of the medium performance component: Z₂=Z₁₂−Z₁

Zipf distribution cumulative value of the low performance component: Z₃=1−Z₁₂

The entire predicted performance is calculated from the maximum I/O frequency of each hierarchical component.

predicted performance of the high performance component: X_{N1}=X_{M1}/Z₁

predicted performance of the medium performance component: X_{N2}=X_{M2}/Z₂

predicted performance of the low performance component: X_{N3}=X_{M3}/Z₃

In X_{N1}, X_{N2}, and X_{N3}, the smallest value is defined as the appropriate predicted performance (optimum performance).

Described next is the method of calculating the optimum usage capacity. As the initial state, as with the case of calculating the optimum performance, assume the state in which all logical capacity is used in all hierarchical components.

In the case in which a hierarchical configuration uses both the medium and low performance components, if the entire I/O frequency calculated from the maximum I/O frequency of the medium performance component is smaller than the value calculated from the low performance component when the optimum performance is calculated, then the hierarchical component whose usage capacity is decreased is the medium performance component.

In the case in which a hierarchical configuration uses both the medium and low performance components, if the entire I/O frequency calculated from the maximum I/O frequency of the low performance component is smaller than the value calculated from the medium performance component when the optimum performance is calculated, then the hierarchical component whose usage capacity is decreased is the low performance component.

Since the hierarchical component from which the usage capacity is decreased, a calculation is performed with the practical usage capacity decreased, and the usage capacity in which the performance is further improved is set as the optimum usage capacity. When the hierarchical configuration uses only one of the medium performance component and the low performance component, the logical capacity is set as the optimum usage capacity.

Considering with senses, the entire performance seems to be improved by giving higher priority to a hierarchical component of higher performance. Practically, from the high performance component (SSD), the more assignment the component is performed, the higher performance it is provided. However, if it is assumed that the distribution of the access frequency is the Zipf distribution, the performance may be improved to decrease the amount of assignment of the medium performance component.

The state in which the logical capacity is completely used is not the optimum usage capacity. Generally, the larger the free capacity is, the higher the performance becomes. The point (usage capacity) in which the performance is the best is calculated while saving the capacity to a certain extent (by storing data in the medium and low performance components). If the usage capacity may be very small, the state in which all capacity is assigned from the high performance component (SSD) is the state in which the highest performance is obtained.

The assigned capacity of the medium or low hierarchical component is decreased from the state in which all logical capacity is assigned in all hierarchical components, and the usage capacity with which the entire performance is the highest is defined as the appropriate usage capacity. Since the more the assignment is performed to the high performance component, the higher the performance becomes, all logical capacity is assigned from the high performance component.

On the other hand, assuming that all logical capacity is assigned, consider from which the assigned capacity is to be decreased, the medium performance component or the low performance component. If the assignment of both of them is decreased, the solution is to assign all capacity from the high performance component. Similarly, in the hierarchical configuration in which only one of the medium and low performance components is used, the solution is to assign all capacity from the high performance component.

Then, assume that the calculation of the optimum performance is used in calculating the optimum usage. As described above, in the calculation of the optimum performance, the entire load is calculated from the maximum I/O frequency obtained from the average response of each hierarchical component, and the minimum value is the appropriate value. The hierarchical component having the minimum value (generally one of Online SAS and Nearline SAS) may be the bottleneck of the performance. Then, the usage capacity of the hierarchical component which is the bottleneck of the performance is decreased, the same calculation as the calculation of the optimum performance is performed, and the usage capacity of the maximum performance is calculated.

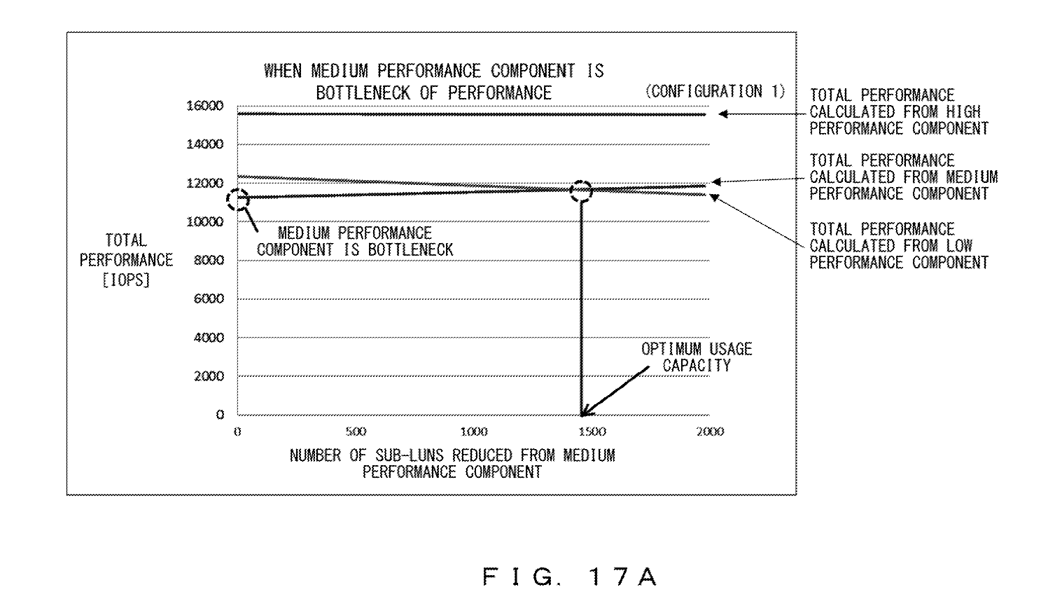

For example, as illustrated in FIG. 16A, when the predicted performance obtained from the low performance component is larger than the predicted performance obtained from the medium performance component, it may be mentioned that the medium performance component is the bottleneck of the performance. In this case, when the usage capacity of the medium performance component is decreased, the (relative) performance of the low performance component is improved. Therefore, the usage capacity of the medium performance component is decreased.

Furthermore, as illustrated in FIG. 16B, when the predicted performance obtained from the medium performance component is larger than the predicted performance obtained from the low performance component, it may be mentioned that the low performance component is the bottleneck of the performance. In this case, when the usage capacity of the low performance component is decreased, the (relative) performance of the medium performance component is improved. Therefore, the usage capacity of the low performance component is decreased.

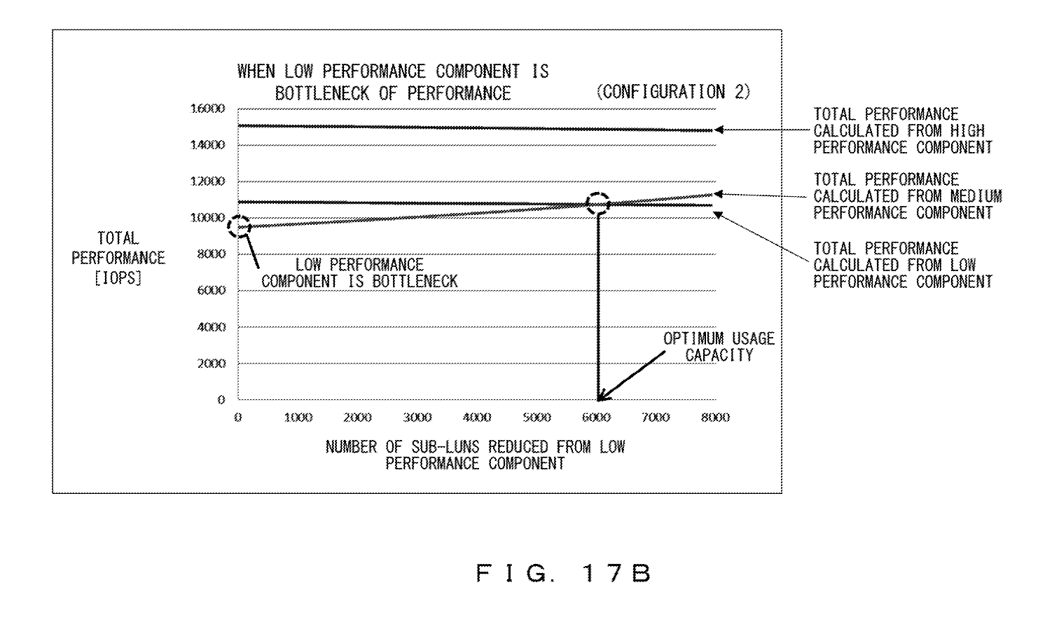

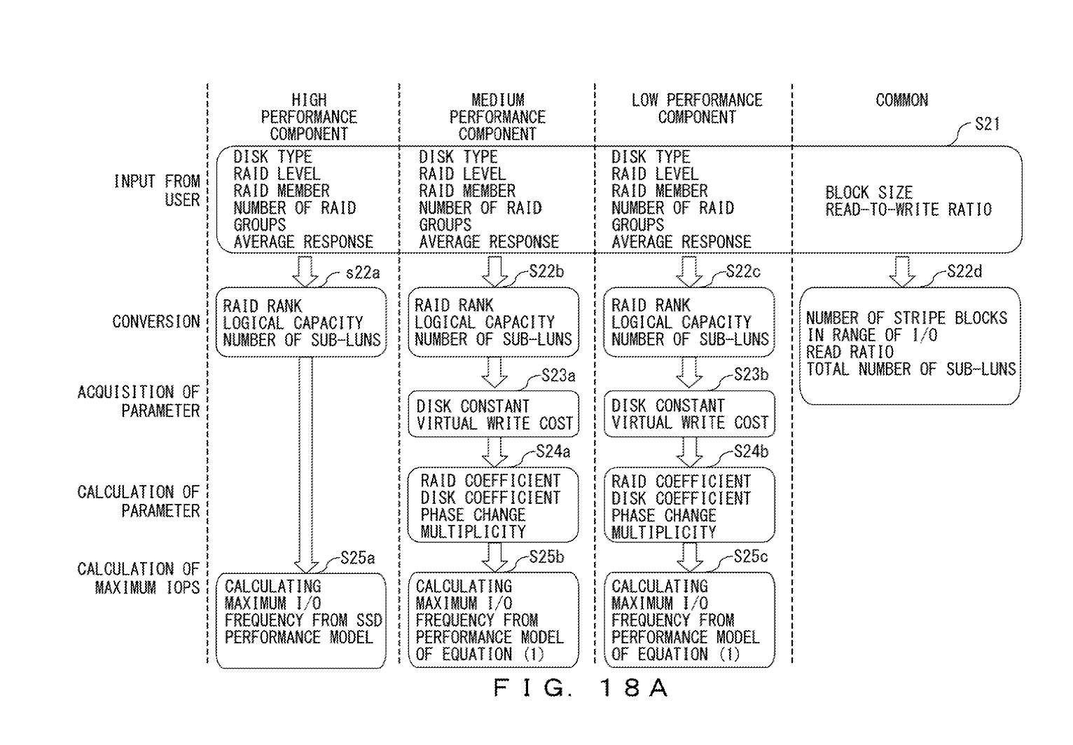

Now, an example of calculating the optimum usage is explained with reference to FIGS. 17A and 17B. FIG. 17A illustrates the relationship between the number of sub-LUNs reduced from the medium performance component and the entire performance calculated from each hierarchical component when the medium performance component is the bottleneck of the performance in the configuration example 1. FIG. 17B illustrates the relationship between the number of sub-LUNs reduced from the low performance component and the entire performance calculated from each hierarchical component when the low performance component is the bottleneck of the performance in the configuration example 2. The configurations of the hierarchical components of configuration examples 1 and 2 are listed below.

### Configuration Example 1

2.5 [inch] SSD 400 [GB] RAID 5 3+1×1

3.5 [inch] Online SAS 600 [GB] RAID 5 7+1×5

2.5 [inch] Nearline SAS 1 [TB] RAID 6 8+2×10

### Configuration Example 2

2.5 [inch] SSD 400 [GB] RAID 5 3+1×1

3.5 [inch] Online SAS 600 [GB] RAID 5 7+1×5

2.5 [inch] Nearline SAS 1 [TB] RAID 6 8+2×6

In the calculation, as illustrated in FIG. 17A, the configuration example 1 indicates the bottleneck of the performance in the medium performance component, and the configuration example 2 indicates the bottleneck of the performance in the low performance component. The number of sub-LUNs of the medium performance component is decreased from the configuration example 1, and the number of sub-LUNs of the low performance component is decreased from the configuration example 2. Then, the entire performance calculated from the hierarchical component which has been the bottleneck is improved. On the other hand, the entire performance calculated from the hierarchical component which has not been the bottleneck (medium performance component or low performance component) is reduced. Since the optimum performance takes the minimum values of three hierarchical components, the value of the optimum usage capacity for which the optimum performance is the maximum may be determined.

Described below is the mathematical ground for that the performance is improved when the usage capacity is reduced. The numbers of sub-LUNs of the high performance component, the medium performance component, and the low performance component are respectively S₁, S₂, and S₃. The entire usage capacity is N=S₁+S₂+S₃.

The I/O frequency thresholds (τ₁₂, τ₁₃) for the total load X are the I/O frequencies applied to the sub-LUNs respectively having the S₁-th and (S₁+S₂)-th largest frequencies. Therefore, they are obtained by the following equation from the Zipf distribution.

$${τ}_{12} = Xf ( {S}_{1} ; N ) = \frac{1}{ln N + γ} \frac{X}{{S}_{1}}$$

$${τ}_{23} = Xf ( {S}_{1} + {S}_{2} ; N ) = \frac{1}{ln N + γ} \frac{X}{{S}_{1} + {S}_{2}}$$

Then, the ratio of the I/O frequency threshold is Σ₁₂/τ₁₃=(S₁+S₂)/S₁, and is determined by the usage capacity of the high performance component and the medium performance component. Therefore, it is known that the usage capacity of the low performance component has no affection.

When the usage capacity of the low performance component is decreased, the ratio of the I/O frequency threshold is unchanged. Therefore, the relative values of two I/O frequency thresholds are not changed. Furthermore, by decreasing the entire usage capacity (N), the value of Z₁₂ slightly increases. Thus, the Zipf distribution cumulative value Z₃ in the low performance component becomes slightly smaller, and the entire performance X_{N3} calculated from the low performance component becomes slightly larger. Furthermore, the increase of the values of Z₁ and Zz₂ by decreasing the entire usage capacity (N) is slightly larger for Z₂. Therefore, the Zipf distribution cumulative value Z₁ in the medium performance component becomes slightly smaller, thereby making the entire performance X_{N2} calculated from the medium performance component slightly smaller.

When the usage capacity of the medium performance component is decreased, the entire usage capacity is decreased as with the usage capacity of the low performance component, and the value of the ratio of the I/O frequency threshold becomes smaller. As compared with τ₁₂, the relative value of τ₂₃ decreases, thereby setting a sharp inclination of a distribution curve, a relatively heavy load is applied to the high performance component, thereby much more improving the entire performance. In the case illustrated in FIG. 17A, the number of sub-LUNs reduced from the medium performance component is 1,500 while in the case illustrated in FIG. 178 the number of sub-LUNs reduced from the low performance component is 6,000. Thus, the difference in reduced capacity between the hierarchical components is four times. Therefore, as compared with the case in which the usage capacity is reduced in the low performance component, the optimum usage capacity is obtained with a less reduced capacity.

Described next in detail is the optimum performance and optimum usage capacity calculating process in the second embodiment. Also in the second embodiment, the process is performed by the computer 20 used according to the first embodiment.

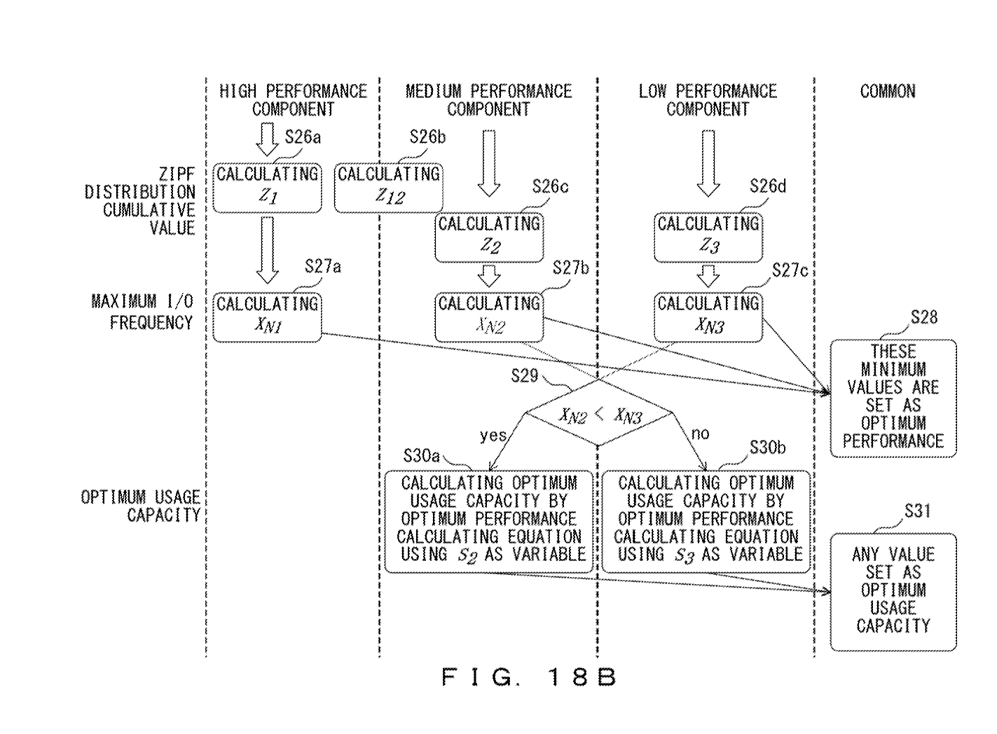

FIGS. 18A and 18B are the flowcharts of the optimum performance and optimum usage capacity calculating process according to the second embodiment. First, the computer 20 accepts the following input from a user (S21).

kinds (type, size, number of revolutions, capacity) of a disk to be used in each hierarchical component (high performance component, medium performance component, low performance component)

RAID level, RAID member, number of RAID groups in each hierarchical component

restriction value of response in each hierarchical component

average block size (average I/O size), read-to-write ratio

Next, the computer 20 converts the input information from a user into an easily computable form (S22a through S22d). That is, the computer 20 acquires the read ratio (c) from the read-to-write ratio. The computer 20 calculates the expectation value (E) of the number of stripe blocks in the range of I/O from the average block size. The computer 20 acquires the RAID rank (R) of each hierarchical component from the RAID member of each hierarchical component. The computer 20 calculates the logical capacity of each hierarchical component from the disk capacity, the RAID level, and the RAID rank (R) of each hierarchical component. The computer 20 calculates the maximum number of sub-LUNs (S₁, S₂, S₃) and the total number of sub-LUNs (N) of each hierarchical component from the logical capacity of each hierarchical component. The computer 20 converts the usage capacity into the number of sub-LUNs (N).

Next, the computer 20 acquires the parameter to be used in the performance model of the equation (1) (S23a, S23b). That is, the computer 20 acquires the respective disk coefficients (D) from the kind of the disk of the medium and low performance components. The computer 20 acquires the virtual write cost (V) of each hierarchical component from the disk coefficient of the medium and low performance components, RAID level, and the average block size. Since the sub-LUN is assigned from any position of the RAID volume in the method of assigning the capacity of a hierarchical storage, the usage ratio (v) of each hierarchical component is set to “1”.

Next, the computer 20 calculates a parameter to be used in the performance model of the equation (1) (S24a, 24b). The computer 20 calculates the RAID coefficient (A) of each hierarchical component from the RAID level, the RAID rank (R), and the expectation value (E) of the number of stripe blocks in the range of I/O of the medium and low performance components. The computer 20 calculates the disk coefficient (a) of each hierarchical component from the RAID level, the RAID rank (R), the expectation value (E) of the number of stripe blocks in the range of I/O, and the disk constant (D) of the medium and low performance components. The computer 20 calculates the phase change multiplicity (F) from the RAID coefficient (A), the disk coefficient (α), the virtual write cost (V), and the read ratio (c) of the medium and low performance components.

Next, the computer 20 calculates the maximum I/O frequency of the high performance component from the above-mentioned performance model of the SSD (S25a). Concretely, the computer 20 calculates the maximum I/O frequency (X₁) in the high performance component from the RAID rank (R) of the SSD, the expectation value (E) of the number of stripe blocks in the range of I/O, the read ratio (c), and the number of read groups.

The computer 20 calculates the maximum I/O frequency of the medium and low performance components using the performance model of the equation (1) (S25b, S25c). The computer 20 calculates an approximate solution of the inverse function of the performance model equation of the equation (1) from the average response, the RAID coefficient (A), the disk coefficient (α), and the phase change multiplicity (ε) of each hierarchical component, thereby calculating the maximum I/O frequency (X₂) of the medium performance component and the maximum I/O frequency (X₃) of the low performance component.

Next, the computer 20 calculates the Zipf distribution cumulative value in each hierarchical component from the maximum number of sub-LUNs of each hierarchical component (S26a through S26d). In this example, the computer 20 calculates the Zipf distribution cumulative value (Z₁) of the high performance component from the total number of sub-LUNs (N) and the maximum number of sub-LUNs (S₁) of the high performance component. Furthermore, the computer 20 calculates the sum of the Zipf distribution cumulative values (Z₁₂) of the high and medium performance components from the total number of sub-LUNs (N), the maximum number of sub-LUNs (S₁) of the high performance component, and the maximum number of sub-LUNs (S₂) of the medium performance component. The computer 20 calculates the Zipf distribution cumulative value (Z₂) of the medium performance component and the Zipf distribution cumulative value (Z₃) of the low performance component using the calculated Zipf distribution cumulative value (Z₁) of the high performance component and the sum of the Zipf distribution cumulative values (Z₁₂) of the high and medium performance components.

Next, the computer 20 calculates the optimum performance from the total I/O frequency calculated from each hierarchical component (S27a through S27c). In this example, the computer 20 the total I/O frequency (X_{N1}) predicted from the high performance component using the maximum I/O frequency (X₁) of the high performance component and the Zipf distribution cumulative value (Z₁) of the high performance component. The computer 20 calculates the total I/O frequency (X_{N2}) predicted from the medium performance component from the maximum I/O frequency (X₂) of the medium performance component and the Zipf distribution cumulative value (Z₂) of the medium performance component. The computer 20 calculates the total I/O frequency (X₃) predicted from the low performance component from the maximum I/O frequency (X₃) of the low performance component and the Zipf distribution cumulative value (Z₃) of the low performance component.

The computer 20 sets as the optimum performance the smallest value in the total I/O frequency (X_{N1}) predicted from the high performance component, the total I/O frequency (X_{N2}) predicted from the medium performance component, and the total I/O frequency (X_{N3}) predicted from the low performance component (S28).

The computer 20 compares the total I/O frequency (X_{N2}) predicted from the medium performance component with the total I/O frequency (X_{N3}) predicted from the low performance component (S29). The computer 20 determines the hierarchical component from which the usage capacity is reduced depending on the result of the comparison, and calculates the optimum usage capacity (S30a, S30b, S31). That is, under X_{N2}<X_{N3}, the computer 20 generates the equation for obtaining the optimum performance with S₂ defined as a variable. The computer 20 decreases the value of S₂, and calculates the value of S₂ with which the equation of the optimum performance obtains the maximum value (S30a). The computer 20 sets as the maximum optimum usage capacity the value of the total number of sub-LUNs (N=S₁+S₂+S₃) (S31). In the case of X_{N2}≧X_{N3}, the computer 20 generates an equation for obtaining the optimum performance when S₁ is variable. The computer 20 decreases the value of S₃, and calculates the value of S₃ with which the equation of the optimum performance obtains the maximum value (S30b). The computer 20 sets as the optimum usage capacity the value of the total number of sub-tUNs (N=S₁+S₂+S₃) (S31).

Described below is the embodiment of the flow in FIGS. 18A and 18B. The following embodiment is realized by the computer 20 in which the program according to the present embodiment is installed. The types of disk which may loaded into hierarchical storage are listed below.

SSD 2.5 [inch] 100 [GB], 200 [GB], 400 [GB]

SSD 3.5 [inch] 100 [GB], 200 [GB], 400 [GB]

Online SAS 3.5 [inch] 15,000 [rpm]300 [GB], 450 [GB], 600 [GB]

Online SAS 2.5 [inch] 15,000 [rpm] 300 [GB]

Online SAS 2.5 [inch] 10,000 [rpm] 300 [GB], 450 [GB], 600 [GB], 900 [GB]

Nearline SAS 3.5 [inch] 7,200 [rpm] 1 [TB], 2 [TB], 3 [TB]

Nearline SAS 2.5 [inch] 7,200 [rpm] 1 [TB]

Since there are three variations of the number of revolutions of the Online SAS disk and the Nearline SAS disk, the disk constants of the respective disks are measured.

disk constant (D₁) of 15,000 [rpm] disk=0.017

disk constant (D₂) of 10,000 [rpm] disk=0.021

disk constant (D₃) of 7,200 [rpm] disk a 0.037

Next, the work load corresponding to the performance evaluation support program is limited, that is, the restrictive condition is set. The first embodiment does not correspond to sequential access, but corresponds to random access. As described above, the random access and read processing is the condition of a 100% cache miss, and write processing is the condition of a 100% cache hit. Since the conditions refer to the worst performance of the RAID in the normal operation, it is considered that the restrictions are significant as the evaluation of the performance.

Furthermore, it is assumed that the average read block size is equal to the average write block size. That is, the average block size=average read block size=average write block size.

A representative value of the average block size may be, for example, 8 [KB], 16 [KB], 32 [KB], or 64 [KB]. A user may select the value closest to any of the representative values.

The virtual write cost (V) corresponding to the restrictive conditions above is measured. FIG. 12 illustrates the results of the measurement of the virtual write cost (V) for each RAID level and for each block size of the three disks above.

In this case, the write response (W_{W}) is also measured. Since it is assumed that the write processing incurs a 100% cache hit, it is assumed that substantially the same value is obtained in all cases. In the second embodiment, it is assumed that the write response (W_{W})=0.000275 [sec].

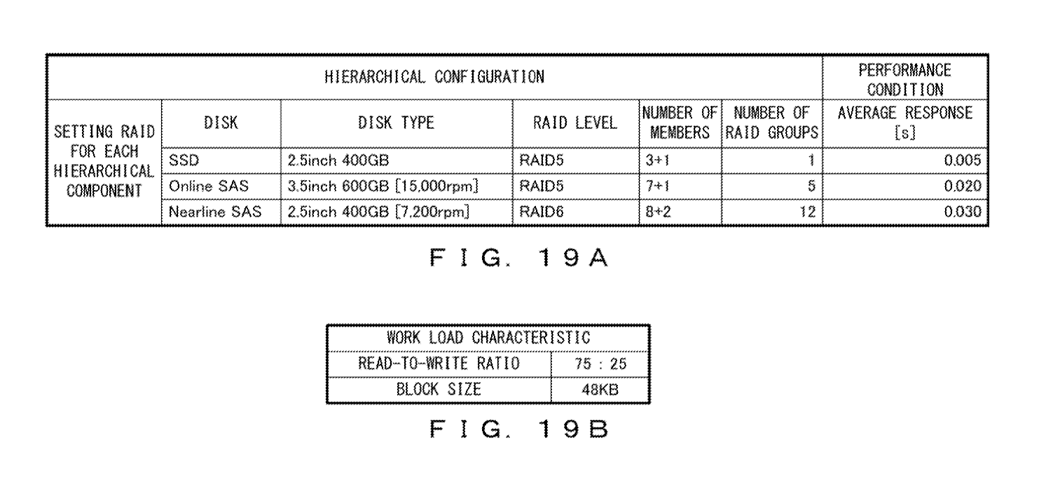

Described next is S21. FIGS. 19A and 19B are examples of the input screen according to the second embodiment. FIG. 19A illustrates an input screen for input of a hierarchical configuration. FIG. 19B illustrates an input screen for input of a setting of a work load characteristic. Assume an example of the input as illustrated below.

high performance component: 2.5 [inch] SSD 400 [GB], RAID 5 3+1, RAID number of groups 1, average response of 5 [msec]

medium performance component: 3.5 [inch] Online SAS 15,000 [rpm] 600 [GB], RAID 5 7+1, RAID number of groups 5, average response 0.020 [sec]

low performance component: 2.5 inch Nearline SAS 7,200 [rpm]1 [TB], RAID 6 8+2, RAID number of groups 12, average response 0.030 [sec]

The read-to-write ratio is 75:25, and the average block size is 48 [KB].

A user capable of grasping the average response of each disk inputs an average response of each disk. A user incapable of grasping the average response of each disk uses a default as an average response of each disk. Furthermore, a user capable of grasping a read-to-write ratio and a block size inputs these values. A user incapable of grasping a read-to-write ratio and a block size uses defaults.

Described next are S22a through S22d. In S22a through S22d, the computer 20 transforms the input information from a user into a computable form. The high performance component is assigned the RAID rank (R)=3. Since the actual capacity of the 400 [GB] disk is 374,528 [MB], the logical capacity=actual capacity×RAID rank×number of RAID groups=374,528×3×1=1,123,584 [MB].

The medium performance component is assigned the RAID rank (R)=7. Since the actual capacity of 600 GB disk is 559, 104 [MB], the logical capacity=actual capacity×RAID rank×number of RAID groups=559,104×7×5=19,567,640 [MB].

The low performance component is assigned the RAID rank (R)=8. Since the actual capacity of 1 [TB] disk is 937,728 [MB], the logical capacity=actual capacity×RAID rank×number of RAID groups=937,728×8×12=90,021,888 [MB].

Assume that the size of the sub-LUN is 1,344 [MB]. In this case, the computer 20 calculates the number of sub-LUNs in each hierarchical component as follows.

The number of sub-LUNs of the high performance component is 1,123,584/1,344=836.

The number of sub-LUNs of the medium performance component is 19,568,640/1,344=14,560.

The number of sub-LUNs of the low performance component is 90,021,888/1,344=66,980.

When the sub-LUN is transferred between hierarchical components, a free capacity is required in the destination hierarchical component. Therefore, the ratio of the free capacity is equally defined as 10%. The computer 20 defines the value obtained by multiplying the number of sub-LUNs in each hierarchical component as the logical capacity of each hierarchical component.

logical capacity (S₁) of sub-LUN unit of high performance component: 836×0.9=752

logical capacity (S₂) of sub-LUN unit of medium performance component: 14,560×0.9=13,104

logical capacity (S₃) of sub-LUN unit of low performance component: 66,980×0.9=60,282

total number of sub-LUNs (N): 752+13,104+60,282=74,138

Since the read-to-write ratio is 75:25, the computer 20 calculates the read ratio (c)=0.75.

The computer 20 calculates the expectation value (E) of the number of stripe blocks in the range of I/O.

Assume that the size (stripe length or strike size) of a stripe block is 64 [KB].

average block size: r=48 [KB]

M=((r−0.5) mod 64)+0.5=48

N=(r−M+64)/64=1

E=(N+1){2M−1)/128}+N {(128−2M+1)/128}=1.7422

Since the average block size is equal to the read average block size, the expectation value E_{R} of the number of stripe blocks in the range of a read is equal to the value of E above.

Described next are S23a through S23b, and S24a through S24b. In S23a through S23b, the computer 20 acquires the parameter used in the performance model of the equation (1) for performance prediction of the medium and low performance components from the input information. In S24a through S24b, the computer calculates the parameter used in the performance model of the equation (1). In the description below, the method of concretely calculating the RAID coefficient, the disk coefficient, and the phase change multiplicity is described in S4 of the first embodiment, and the explanation is omitted here.

In the medium performance component,

disk constant: D=0.017

virtual write cost: V=0.0262

RAID coefficient: A=2.3455

disk coefficient=α−0.003017

phase change multiplicity: E=0.4476

In the low performance component,

disk constant: D=0.037

virtual write cost: V=0.1393

RAID coefficient: A=3.5741

disk coefficient=α=0.004309

phase change multiplicity: E=0.2485

Described next are S25b through S25c. In S25b through S25c, the computer 20 calculates the maximum I/O frequency of each hierarchical component using the performance model of the equation (1) for the performance of the medium and low hierarchical components from the input information. As in S5 in the first embodiment of the present invention, when the maximum I/O frequency of the entire medium performance component is calculated, the maximum I/O frequency=2817.774 of the medium performance component is acquired. Also relating to the maximum I/O frequency of the entire low performance component, the maximum I/O frequency=1934.883 of the low performance component is acquired.

Described next is S25a. In S25a, the computer 20 calculates the maximum I/O frequency of the high performance component from the performance model of the SSD according to the input information. Since the high performance component is SSD RAID 5 3+1 (RAID rank=3), the proportion coefficient×RAID rank=1400×3=4200 [IOPS] is calculated for the write maximum performance of the SSD. Since the read ratio is 0.75, and the expectation value of the stripe block in the range of I/O is 1.7422, the result of the calculation of the maximum performance of the SSD is 4200/(1−0.75)/1.7422=9642.98. Since the number of RAID groups of the high performance component is “1”, the maximum I/O frequency of the high performance component is 9642.98

Described next is S26a through S26d. In S26a through S26d, the computer 20 calculates the Zipf distribution cumulative value of each hierarchical component from the number of sub-LUNs in the maximum capacity.

Zipf distribution cumulative value of high performance component: Z₁=(1n S₁+γ)/(1n N+γ)=(1n 712+0.5772)/(1n 71,372+0.5772)=0.6106

sum of Zipf distribution cumulative values of high performance component and medium performance component: Z₁₂=(1n (S₁+S₂)+γ)/(1n N+γ)=(1n (752+13,104)+0.5772)/(1n 71,372+0.5772)=0.8578

Zipf distribution accumulation of medium performance component: Z₂=Z₁₂−Z₁=0.2472

Zipf distribution accumulation of low performance component: Z₃=1−Z₂=0.1422

Described next are S27a through S27c, and S28. In S27a through S27c, the computer 20 calculates the entire maximum performance of each hierarchical component as described below.

high performance component: X_{N1}=X_{M1}/Z₁=9,642.98/0.6106=15,792.63

medium performance component: X_{N1}=X_{M2}/Z₂=2,817.774/0.2472=11,398.76

low performance component: X_{M3}=X_{M3}/Z₃=1,934.883/0.1422=13,606.77

The smallest value of the calculated and predicted performance is the maximum performance (X_{N2}) calculated from the medium performance component, the computer 20 sets X_{N2} as the optimum performance.

Described next is S29, S30a through S30b, and S31. In S27a through S27c, the computer 20 provides the operations from the calculated Zipf distribution cumulative value to the calculation of the optimum performance by the equation for a cell to calculate the optimum usage capacity using the solver function in Microsoft Excel (registered trademark).

value of A1 cell: number of sub-LUNs of high performance component=752

value of B1 cell: number of sub-LUNs of medium performance component=13,104

value of C1 cell: number of sub-LUNs of low performance component=60,282

equation of D1 cell: “=A1+B1+C1”

equation of A2 cell: calculation equation of Zipf distribution cumulative value Z₁ “=(LN (A1)+0.5772)/(LN (D1)+0.5772)”

equation of B2 cell: calculation equation of Zipf distribution cumulative value Z₂ “=((LN (A1+B1)+0.5772)/(LN (D1)+0.5772))−A2”

equation of C2 cell: calculation equation of Zipf distribution cumulative value Z₃“=1−((LN (A1+B1)+0.5772)/(LN (D1)+0.5772)”

equation of A3 cell: calculation equation of X_{N1} “=9,642.98/A2”

equation of A3 cell: calculation equation of X_{N2} “=2,817.774/B2”

equation of A3 cell: calculation equation of X_{N3} “=1,934.883/C2”

equation of D3 cell: “=MIN (A3, B3, C3)”

The computer 20 provides the following conditions to the solver to calculate the optimum usage capacity. In calculating the optimum performance, X_{N2}<X_{N3} holds true. The computer 20 inputs to the solver the conditions of the object cell D3, the maximum value as the target value, and the variable cell B1. Furthermore, in the calculation of the optimum performance, the computer 20 inputs the condition of C1 as the variable cell in the case of X_{N2}≧X_{N3}. When the computer 20 obtains a solution by the solver of the condition, it obtains the value of 10,337.27=10,337 in the B1 cell as the number of sub-LUNs of the medium performance component. In this case, the total value of 71,371 of the number of sub-LUNs of all hierarchical components is output to the D1 cell. Since the size of the sub-LUN is 1,334 [MB], 71,371×1,344 [MB]=91.48 [TB] is obtained as the optimum usage capacity.

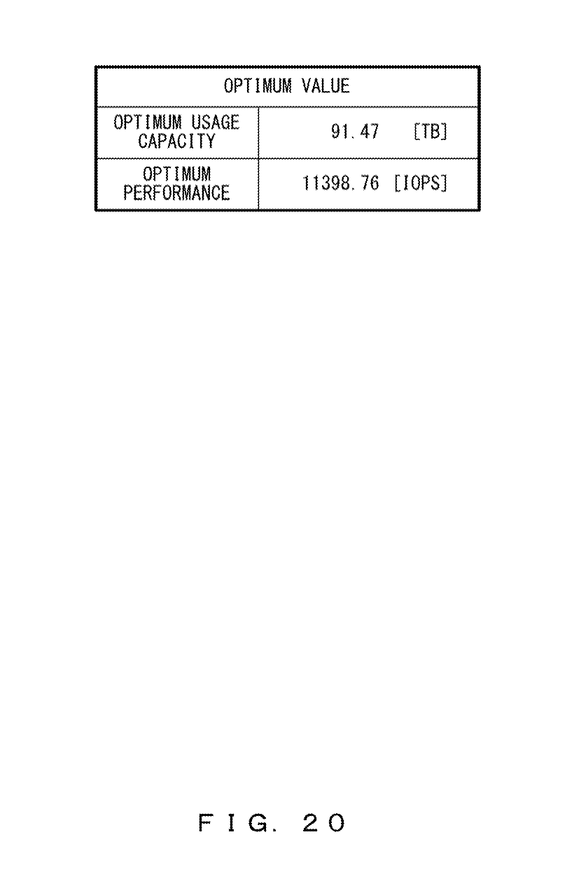

Since the calculation is completed as described above, the computer 20 displays the result of the calculation as illustrated in FIG. 20.

As described above, since the hierarchical storage is realized by the combination of a plurality of storage units having different performance, it is generally difficult to evaluate the performance.

However, using the second embodiment, the performance value may be output by an arbitrary combination, and the reference may be set that a safe operation is performed until the practical load reaches the performance value. As a result, a guide to the operation may be generated.

Furthermore, higher performance is generally obtained to keep a free capacity than the state in which the maximum available capacity is completely used, but the exact capacity may be output, and the guide to the operation may be generated when the hierarchical storage is practically operated.

According to the second embodiment, based on the assumption that the bias of the access frequency for each sub-LUN depends on the Zipf distribution, the optimum performance and the optimum usage capacity in the hierarchical storage having an arbitrary configuration may be calculated. By the performance model by the equation (1), the maximum I/O frequency that satisfies the average response condition of each hierarchical component is calculated, and using the Zipf distribution, the maximum performance value (I/O frequency) that satisfies the performance condition above may be calculated for all hierarchical components with arbitrary usage capacity.

From the result of the calculation of the optimum performance above, the hierarchical component which is the bottleneck of performance may be defined, and by decreasing the usage capacity of the hierarchical component, the optimum usage capacity may be calculated. Considering with senses, the entire performance seems to be best improved storing data in order from the hierarchical component of the highest performance. However, there is the case in which the highest performance is obtained by practically decreasing the usage capacity of the medium performance component. Then, from the mathematical consideration in the case of decrease from the medium performance component, it is known that the entire performance is higher to keep a larger capacity of the low performance component than a larger capacity of the medium performance component.

According to an aspect of the present embodiment, evaluation support may be performed for the performance of a storage system.

The first and second embodiments are not limited to the embodiments described above, but may use various configurations or embodiments within the scope of the gist of the present invention.

All examples and conditional language provided herein are intended for pedagogical purposes of aiding the reader in understanding the invention and the concepts contributed by the inventor to further the art, and are to be construed as being limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium having stored therein a program for causing a computer to execute a process for calculating a reference value of performance evaluation of a storage system, the process comprising:
acquiring information about a configuration of each of a plurality of storage device groups which are included in a storage system and have a different response efficiency to a request including at least one of a read request and a write request, and information about a maximum response time to the request of each storage device group;
calculating a maximum request issuance frequency as a request issuance frequency per unit time as the maximum response time when a response time is checked for each of the plurality of storage device groups using the acquired information;
calculating an cumulative value of a number of issuance of requests to each storage device group from a Zipf distribution when the request issuance frequency to a unit capacity in the plurality of storage device groups and a probability of the request issuance frequency are in accordance with the Zipf distribution; and
generating an evaluation reference value about the storage device group using the maximum request issuance frequency and the cumulative value of the number of issuances of the request.

2. The non-transitory computer-readable recording medium according to claim 1, wherein
in generating the evaluation reference value, a first storage device group having a highest response efficiency in the plurality of storage device groups is assigned a same capacity as a logical capacity of the first storage device group, and for a storage device group other than the first storage device group, a capacity with which the request issuance frequency is a maximum value for response in the maximum response time is calculated using a cumulative value of a number of issuance of the request of the storage device group.

3. The non-transitory computer-readable recording medium according to claim 1, wherein
a ratio of a logical capacity of each of the plurality of storage device groups is calculated in generating the evaluation reference value.

4. The non-transitory computer-readable recording medium according to claim 1, wherein
in generating the evaluation reference value, the request issuance frequency per unit time among the storage device groups is calculated using the request issuance frequency per unit time for the plurality of storage device groups specified in advance and the Zipf distribution.

5. The non-transitory computer-readable recording medium according to claim 1, wherein
in generating the evaluation reference value, the request issuance frequency per unit time among the storage device groups is calculated using a smallest value in values obtained by dividing the maximum request issuance frequency for each storage device group by the cumulative value of the number of issues of requests and the Zipf distribution.

6. The non-transitory computer-readable recording medium according to claim 1, wherein
in generating the evaluation reference value, a smallest value in values obtained by dividing the maximum request issuance frequency for each storage device group by the cumulative value of a number of issuance of requests to the storage device group is output.

7. The non-transitory computer-readable recording medium according to claim 6, wherein
in the values obtained by the division, the values corresponding to second and third storage device groups as the storage devices other than the first storage device group having highest response efficiency in the plurality of storage device groups are compared with each other, and a storage device group corresponding to a smaller value as a result of the comparison is determined; and
a storage capacity with which the number of requests to be processed by the storage device group is largest is calculated by reducing a storage capacity of the determined storage device group from a maximum capacity.

8. A performance evaluation support apparatus which calculates a reference value of performance evaluation of a storage system, the performance evaluation support apparatus comprising:
a memory; and
a processor configured to perform a process including:
acquiring information about a configuration of each of a plurality of storage device groups which are included in a storage system and have a different response efficiency to a request including at least one of a read request and a write request, and information about a maximum response time to the request of each storage device group;
calculating a maximum request issuance frequency as a request issuance frequency per unit time as the maximum response time when a response time is checked for each of the plurality of storage device groups using the acquired information:
calculating an cumulative value of a number of issuance of requests to each storage device group from a Zipf distribution when the request issuance frequency to a unit capacity in the plurality of storage device groups and a probability of the request issuance frequency are in accordance with the Zipf distribution; and
generating an evaluation reference value about the storage device group using the maximum request issuance frequency and the cumulative value of the number of issuances of the request.

9. The performance evaluation support apparatus according to claim 8, wherein
in the generating of the evaluation reference value, a first storage device group having a highest response efficiency in the plurality of storage device groups is assigned a same capacity as a logical capacity of the first storage device group, and for a storage device group other than the first storage device group, a capacity with which the request issuance frequency is a maximum value for response in the maximum response time is calculated using a cumulative value of a number of issuance of the request of the storage device group.

10. The performance evaluation support apparatus according to claim 8, wherein
a ratio of a logical capacity of each of the plurality of storage device groups is calculated in the generating of the evaluation reference value.

11. The performance evaluation support apparatus according to claim 8, wherein
in the generating of the evaluation reference value, the request issuance frequency per unit time among the storage device groups is calculated using the request issuance frequency per unit time for the plurality of storage device groups specified in advance and the Zipf distribution.

12. The performance evaluation support apparatus according to claim 8, wherein
in the generating of the evaluation reference value, the request issuance frequency per unit time among the storage device groups is calculated using a smallest value in values obtained by dividing the maximum request issuance frequency for each storage device group by the cumulative value of the number of issues of requests and the Zipf distribution.

13. The performance evaluation support apparatus according to claim 8, wherein
in the generating of the evaluation reference value, a smallest value in values obtained by dividing the maximum request issuance frequency for each storage device group by the cumulative value of a number of issuance of requests to the storage device group is output.

14. The performance evaluation support apparatus according to claim 13, wherein
in the generating of the evaluation reference value, the values corresponding to second and third storage device groups as the storage devices other than the first storage device group having highest response efficiency in the plurality of storage device groups are compared with each other, and a storage device group corresponding to a smaller value as a result of the comparison is determined; and
a storage capacity with which the number of requests to be processed by the storage device group is largest is calculated by reducing a storage capacity of the determined storage device group from a maximum capacity.

15. A method for calculating a reference value of performance evaluation of a storage system executed by a computer, the method comprising:
acquiring, by using the computer, information about a configuration of each of a plurality of storage device groups which are included in a storage system and have a different response efficiency to a request including at least one of a read request and a write request, and information about a maximum response time to the request of each storage device group;
calculating, by using the computer, a maximum request issuance frequency as a request issuance frequency per unit time as the maximum response time when a response time is checked for each of the plurality of storage device groups using the acquired information;
calculating, by using the computer, an cumulative value of a number of issuance of requests to each storage device group from a Zipf distribution when the request issuance frequency to a unit capacity in the plurality of storage device groups and a probability of the request issuance frequency are in accordance with the Zipf distribution; and
generating, by using the computer, an evaluation reference value about the storage device group using the maximum request issuance frequency and the cumulative value of the number of issuances of the request.
